(19) United States
(12) Patent Application Publication
(10) Pub. No.: US 2009/0327037 A1
(43) Pub. Date: Dec. 31, 2009

(54) System and Methods for Pricing Markdown with Model Refresh and Reoptimization

(76) Inventors: Charles Tze Chao Ng, Union City, CA (US); Thuan-Luyen Le, Cupertino, CA (US); Saibal Bhattacharya, San Mateo, CA (US); Rob Parkin, San Francisco, CA (US); Paritosh Desai, Santa Clara, CA (US)

Correspondence Address: KANG LIM, 3494 CAMINO TASSAJARA ROAD #436, DANVILLE, CA, 94506, US

(21) Appl. No.: 12/208,342

(22) Filed: Sep. 11, 2008

Related U.S. Application Data
(63) Continuation-in-part of application No. 11/365,634, filed on Feb. 28, 2006.

(51) Int. Cl. G06Q 10/00; G06Q 30/00

(52) U.S. Cl. 705/10

(57) ABSTRACT

A system and method for tuning markdown plans is provided. Such a system and method may include configuring initial rule set. Initial Demand models are generated. A first optimization for inventory pricing may be received from the price optimization system. The first optimization uses the initial demand models and cost data. A markdown plan is generated by applying the initial rule set to the first optimization. The plan is implemented. Updated data may be received which mandates a re-optimization of the plan. Demand models are refreshed using the updated data. Initial rule set is updated by cross referencing plan history with the initial rule set and subtracting rule events that have previously occurred. A second optimization is received which uses the refreshed demand models and cost data. Then, the markdown plan is re-optimized by applying the updated rule set to the second optimization. The re-optimized markdown plan is reported, approved and implemented.

### CROSS REFERENCE TO RELATED APPLICATIONS

This is a continuation-in-part of co-pending U.S. application Ser. No. 11/365,634 filed on Feb. 28, 2006, entitled “Computer Architecture”, which is hereby fully incorporated by reference.

### BACKGROUND OF THE INVENTION

The present invention relates to systems and methods for pricing markdown planning. In particular, the present invention includes generating an optimized markdown plan, and tuning the markdown plan, including demand model refresh and re-optimization, as needed.

In business and other areas, large quantities of information needs to be recorded, processed, and mathematically manipulated to make various determinations. From these determinations, decisions may be made. These decisions may heavily influence the ultimate success of the business.

Likewise, the discount schedule, or markdown plan, is important for the management of inventory and to ensure competitiveness in the market.

For example, in businesses, prices of various products must be set. Such prices may be set with the goal of maximizing margin or demand or for a variety of other objectives. Margin is the difference between total revenue and costs. Total sales revenue is a function of demand and price, where demand is a function of price. Demand may also depend on the day of the week, the time of the year, the price of related products, location of a store, the location of the products within the store, advertising and other promotional activity both current and historical, and various other factors. As a result, the function for forecasting demand may be very complex. Costs may be fixed or variable and may be dependent on sales volume, which in turn depends on demand. As a result, the function for forecasting margin may be very complex. For a chain of stores with tens of thousands of different products, identifying the relevant factors for each product and store, then determining a function representing that demand are difficult.

The enormous amount of data that must be processed for such determinations is too cumbersome, even when done by computer. Further, the methodologies used to forecast demand and the factors that contribute to it require the utilization of non-obvious, highly sophisticated statistical processes.

Such processes are described in U.S. patent application Ser. No. 09/742,472, entitled IMPUTED VARIABLE GENERATOR, filed Dec. 20, 2000 by Valentine et al., and U.S. patent application Ser. No. 09/741,958, entitled PRICE OPTIMIZATION SYSTEM, filed Dec. 20, 2000 by Neal et al., which both are incorporated by reference for all purposes.

These afore mentioned methodologies for forecasting demand may be utilized to generate a markdown plan which optimizes some goal. Currently, such markdown plan generation systems are inefficient and are not capable of dealing with changes in goals, constraints, or unexpected factors that occur post optimization.

Therefore, it is desirable to provide an efficient process and methodology for determining the pricing markdown of individual products, through a markdown plan, such that the markdown plan is optimized, and wherein the markdown plan is capable of being dynamically re-optimized on demand. Moreover, the markdown plans may be executed to be easily/automatically updated to reflect current business conditions.

### SUMMARY OF THE INVENTION

To achieve the foregoing and other objects and in accordance with the purpose of the present invention, a system and method for tuning markdown plans is provided. Such a system and method may be useful in association with a price optimization system.

The system and method for markdown plan tuning may include configuring initial rule set. This configuration may be done by a user or may be automatically implemented. Default rules may also be provided in some embodiments.

The initial rule set may include at least one of enforced markdowns, objective, start date, markdown tolerance, point-of-sales handling rules, cost rules, salvage rules, continuous markdown and item selection. The objective rules may include selecting at least one of a volume objective, a profit objective and an inverse weighing objective. Additionally, in some embodiments, a combination of the volume objective, the profit objective and the inverse weighing objective may be utilized. The inverse weighing objective may include applying a weighing coefficient to the maximization of sales. This weighing coefficient may be a function of time, or other suitable measure.

In some embodiments, a first optimization for inventory pricing may be received from the price optimization system. This optimization may utilize demand models generated by an econometric engine, and cost data from a financial engine. Occasionally, the optimization may include failures. In these situations the failure(s) may result in a partial solve for the optimization.

A plan may then be generated by applying the initial rule set to the first optimization. The plan may then be implemented.

In some embodiments, updated data may be received which mandates a re-optimization of the plan. The updated data may include at least one of point-of-sales data, user implemented rule changes, out date changes, cost data changes, and inventory changes. Demand models may be refreshed using the updated data. Additionally, rules may be updated.

Updating the initial rule set includes looking up plan history, cross referencing plan history with the initial rule set; and updating rule parameters. Cross referencing plan history with the initial rule set includes identifying rule events that have occurred in the plan history. The rule parameters are updated by subtracting rule events that have occurred in the plan history from the initial rule set.

Then, a second optimization of inventory prices may be received from the optimization system. The second optimization may be generated from the refreshed demand models and cost data.

Then the markdown plan may be re-optimized by applying the updated rule set to the second optimization. The re-optimized plan may be reported. The reporting may include generating at least one of an overall report which highlights all markdown plan changes, a cross category report which summarizes specific schedule changes to the markdown plan, an exception based report and a financial forecast for the re-optimized markdown plan.

The re-optimized markdown plan then requires approval from a user. Lastly, the re-optimized markdown plan may be implemented.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a high level schematic view of an optimizing system for markdown plan generation and reoptimization, in accordance with one embodiment of the invention;

FIGS. 2A and 2B illustrate flow charts of a process that uses the optimizing system of FIG. 1;

FIG. 3 shows a schematic view of an econometric engine of the optimizing system of FIG. 1;

FIG. 4 shows a schematic illustration of an example of a flow through of the optimizing system of FIG. 1;

FIG. 5 shows a schematic view of a network that may be used in an embodiment of the invention;

FIGS. 6A and 6B show views of a computer system that may be used in an embodiment of the invention;

FIG. 7 illustrates composition of an EDTSE flow and flow segments of the optimizing system of FIG. 1;

FIG. 8 provides a specific example of an EDTSE flow and flow segments of the optimizing system of FIG. 1;

FIG. 9 shows a more detailed flow of any of first, second, and third imputed display variable processes of the optimizing system of FIG. 1;

FIG. 10 shows a flow that illustrates a process of going from a single input data set to multiple parallel processes;

FIG. 11 shows a schematic illustration of an internal structure of an EDTSE flow segment at run time;

FIG. 12 shows a screen shot that shows a simple indicator model for health products for various product categories;

FIG. 13 shows a screen shot that shows the screen shot of FIG. 12, but with a right-click menu;

FIG. 14 shows a screen shot that shows the values of several competitor price indices;

FIG. 15 shows a schematic illustration of part of a screen that shows an option of implementing a tuned plan;

FIG. 16 shows an exemplary block diagram for the system for markdown plan generation and reoptimization, in accordance with an embodiment of the present invention;

FIG. 17 shows an exemplary block diagram for the markdown plan tuner, in accordance with the system of FIG. 16;

FIG. 18 shows a flow chart illustrating high level process for the generating and re-optimizing markdown plans in accordance with a first embodiment of the present invention;

FIG. 19 shows a flow chart illustrating high level process for the generating and re-optimizing markdown plans in accordance with a second embodiment of the present invention;

FIG. 20 shows a flow chart illustrating configuring the rules for markdown plan development in accordance with an embodiment of the present invention;

FIG. 21 shows a flow chart illustrating markdown objective configuration in accordance with an embodiment of the present invention;

FIG. 22 shows a flow chart illustrating setting inverse weighting objectives for the markdown plan in accordance with an embodiment of the present invention;

FIG. 23 shows a flow chart illustrating configuring rules for handling point of sales data for the markdown plan model refresh in accordance with an embodiment of the present invention;

FIG. 24 shows a flow chart illustrating markdown plan generation in accordance with an embodiment of the present invention;

FIG. 25 shows a flow chart illustrating determination of markdown plan change in accordance with an embodiment of the present invention;

FIG. 26 shows a flow chart illustrating markdown plan rule updating in accordance with an embodiment of the present invention;

FIG. 27 shows a flow chart illustrating markdown plan re-optimization in accordance with an embodiment of the present invention.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well-known process steps and/or structures have not been described in detail in order to not unnecessarily obscure the present invention. The features and advantages of the present invention may be better understood with reference to the drawings and discussions that follow.

The present invention relates generally to systems and methods for pricing markdown. In particular, the present invention includes generating an optimized pricing markdown plan, and tuning the markdown plan, including re-optimization, as needed. The markdown process consists of an initial optimization of a markdown plan, followed by continuous monitoring of that plan versus the originally expected result. Since markdown plans are often for products with volatile short lifecycles, it is important to continually adjust and update the markdown plan to ensure the best possible result.

These adjustments to the plan may include refreshing the demand models to ensure they account for the most current understanding of consumer demand and any changes to the target out date (which impacts the lifecycle curve); re-running the markdown optimizations (reoptimization) to reflect current inventory positions, while incorporating information about actual markdown occasions taken to date; and providing a summary of the changes to the markdown plan. This summary may include an overall reforecast of the plan, as well as exception reporting that highlights specific changes to plans.

Since Markdowns typically occur in a very short time window, the speed which these processes are turned around is critical, and thus implies the need for an ability to kick off an automated batch process.

In price markdown planning, it is desirable to use data to create optimization plans. For example, in the retail industry, it is desirable to use sales data to optimize margin (profit) by setting optimized prices or by optimizing promotions. For retail chains that carry a large variety of items, the optimizations may be performed less than three times a year due to the slowness in processing data due to the large quantities of data and the complex processing involved. As a result, changes in the market or a flaw in an optimization may not be noticed for several months, or may never be noticed.

The present invention is enabled to process large amounts of data, perform complex operations in a short time period, and provide frequently updated data analysis. Additionally, the invention has the unique ability to undergo re-optimization as needed due to changes in rule, goal or empirical data. Thus, if a six-month sales markdown plan is created and implemented, within the first few weeks of the markdown plan, an updated analysis may be made to determine if the markdown plan is incorrect or if conditions of the market have changed, and then generate an updated (tuned) markdown plan, if needed. The invention may provide a flag or some other indicator to suggest whether tuning is desirable and then provide updated information to a user and then allow a user to revise and implement an updated markdown plan.

Moreover, a data transformation and synthesis platform is provided, which allows a scalable and parallel system for processing large amounts of data.

I. Optimization System

To facilitate understanding, an embodiment of the invention will be provided as part of a price optimization system. The purpose of the price optimization system is to receive raw data that relates to a specified econometric problem and to produce coefficients for econometric modeling variables that represent the significant factors affecting the behaviors represented by the data. In one example, the price optimization system produces coefficients that represent the driving factors for consumer demand, synthesized from sales volume and other retail-business related data inputs.

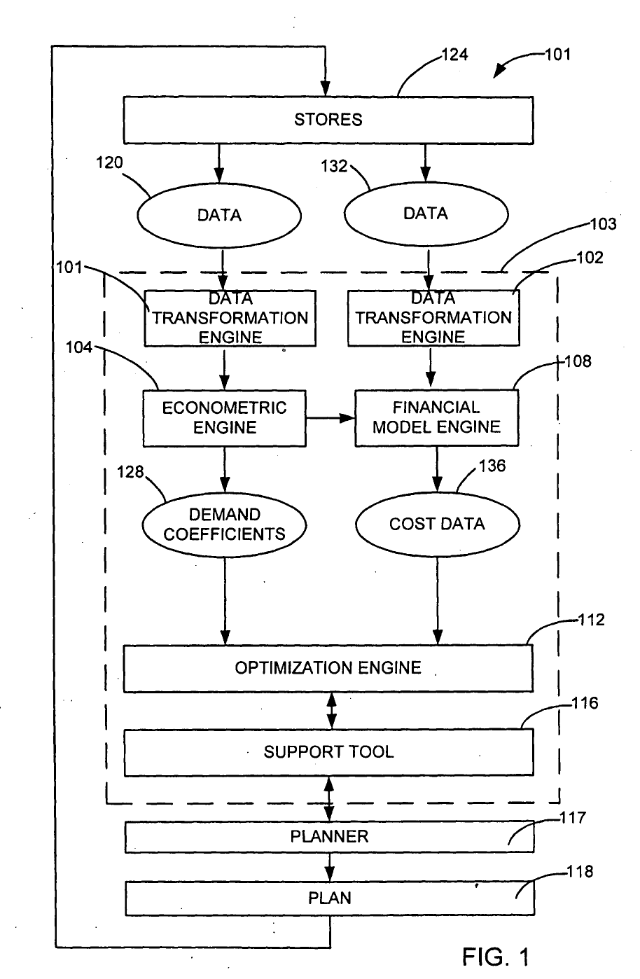

FIG. 1 is a schematic view of an optimizing system 100 using a processing system 103. The processing system 103 comprises a first data transformation engine 101, a second data transformation engine 102, econometric engine 104, a financial model engine 108, an optimization engine 112, and a support tool 116. The econometric engine 104 is connected to the optimization engine 112, so that the output of the econometric engine 104 is an input of the optimization engine 112. The financial model engine 108 is connected to the optimization engine 112, so that the output of the financial model engine 108 is an input of the optimization engine 112. The optimization engine 112 is in two-way communications with the support tool 116 so that output of the optimization engine 112 is provided as input to the support tool 116. The support tool 116 is in two-way communication with a planner 117, who is a user. The planner 117 may use the support tool to generate a plan 118. The plan 118 is implemented by the stores 124.

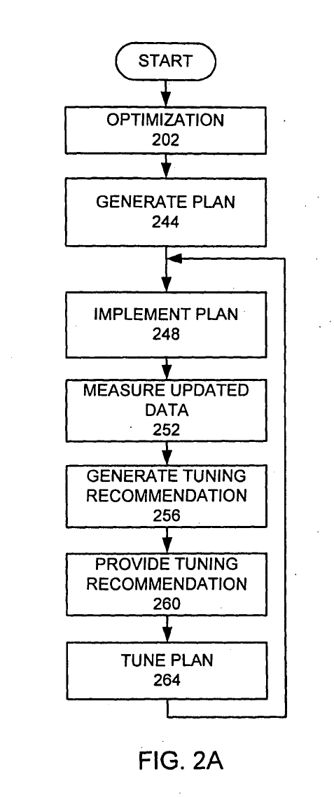

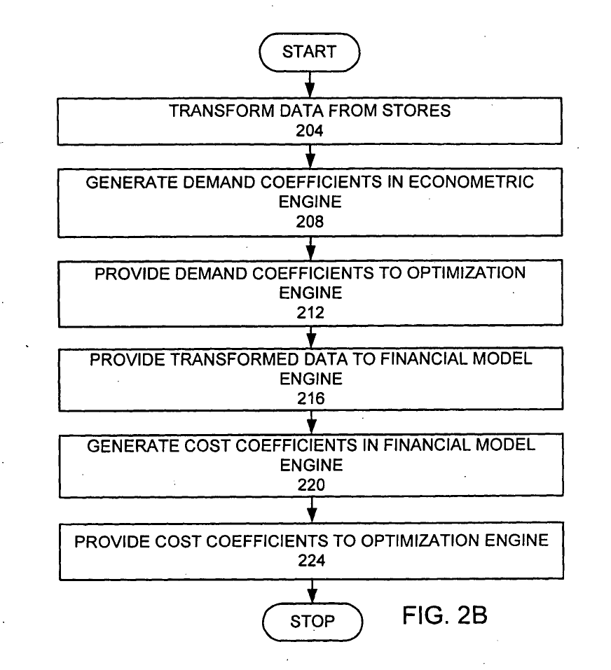

FIG. 2A is a high level flow chart of an optimizing process that uses the optimizing system 100. An optimization is performed (step 202).

II. Business Planning System

FIG. 2B is a more detailed flow chart of the optimization (step 202). Data 120, 132 is provided from the stores 124 to the first data transformation engine 101 and the second data transformation engine 102, where the data from the stores is transformed (step 204). Generally, the data provided to the first data transformation engine 101 and the second data transformation engine 102 may be point-of-sale information, product information, and store information. The transformed data from the first data transformation engine 101 is then provided to the econometric engine 104. The econometric engine 104 processes the transformed data to provide demand coefficients 128 (step 208) for a set of algebraic equations that may be used to estimate demand (volume sold) given certain marketing conditions (i.e., a particular store in the chain), including a price point. The demand coefficients 128 are provided to the optimization engine 112 (step 212). Additional processed data from the econometric engine 104 may also be provided to the optimization engine 112. The financial model engine 108 may receive transformed data from the second data transformation engine 102 (step 216) and processed data from the econometric engine 104. The transformed data is generally cost related data, such as average store labor rates, average distribution center labor rates, cost of capital, the average time it takes a cashier to scan an item (or unit) of product, how long it takes to stock a received unit of product and fixed cost data. The financial model engine 108 may process the data to provide a variable cost and fixed cost for each unit of product in a store (step 220). The processing by the econometric engine 104 and the processing by the financial model engine 108 may be done in parallel. Cost data 136 is provided from the financial model engine 108 to the optimization engine 112 (step 224). The optimization engine 112 utilizes the demand coefficients 128 to create a demand equation. The optimization engine is able to forecast demand and cost for a set of prices to calculate net profit (margin).

A plan is then generated (step 244). In order to generate a plan, the planner 117 provides to the support tool 116 optimization rules. The optimization engine 112 may use the demand equation, the variable and fixed costs, and the rules to compute an optimal set of prices that meet the rules. The planner 117 may be able to provide different sets of rules to create different scenarios to determine different “What if” outcomes. From the various scenarios and outcomes, the planner is able to create a plan.

For example, if a rule specifies the maximization of profit, the optimization engine would find a set of prices that cause the largest difference between the total sales and the total cost of all products being measured. If a rule providing a promotion of one of the products by specifying a discounted price is provided, the optimization engine may provide a set of prices that allow for the promotion of the one product and the maximization of profit under that condition. In the specification and claims, the phrases “optimal set of prices” or “preferred set of prices” are defined as a set of computed prices for a set of products where the prices meet all of the rules. The rules normally include an optimization, such as optimizing profit or optimizing volume of sales of a product and constraints such as a limit in the variation of prices. The optimal (or preferred) set of prices is defined as prices that define a local optimum of an econometric model, which lies within constraints specified by the rules. When profit is maximized, it may be maximized for a sum of all measured products. Such a maximization, may not maximize profit for each individual product, but may instead have an ultimate objective of maximizing total profit.

For a price optimization plan, the optimal set of prices is the plan. The plan may be for a long term. For example, the plan may set weekly prices for the next six months.

The plan is then implemented (step 248). This may be done by having the planner 117 send the plan 118 to the stores 124 so that the stores carry out the plan. In one embodiment, the support tool provides a graphic user interface that provides a button that allows the planner to implement the plan. The support tool would also have software to signal to the stores to implement the plan. In another embodiment, software on a computer used by the planner would integrate the user interface of the support tool with software that allows the implementation of the plan displayed by the support tool by signaling to the stores to implement the plan.

The results of the plan are measured with updated data (step 252). Updated data may be provided on a weekly or daily basis. The updated data may be sent to the processing system 103.

The updated data is used to generate a tuning recommendation (step 256). This may be done in various ways. One way is by generating a new plan, which may be compared with the long range plan. Another way may be to use the updated data to see how accurate the long range plan was for optimization or for prediction of sales. Other data may be measured to determine if tuning should be recommended without modeling the updated data.

In one embodiment, the detection of changes to externally defined cost and competitive price information, and updates to the plan required to maintain business rule conformance are used as factors to determine whether tuning is needed. To detect such factors, the econometric model is not needed, but instead other factors are used. The econometric model may then be updated based on such changes to “tune” the optimized plan for changing conditions

In another embodiment, tuning is performed when certain threshold conditions are reached—i.e., changes are substantial enough to materially impact the quality of the previously optimized plan. In such processes, the econometric model may be used to provide predictions and then compared to actual data.

The system is able to provide a tuning recommendation (step 260). This may be implemented by setting a range or limits either on the data itself or on the values it produces. In the first case, if changes to the updated data relative to the original data exceed a limit or move beyond a certain range, a flag or other indicator may be used to recommend tuning to the user. In the second case, if the updated data creates prediction errors beyond the specified range or limits, a flag may be used to recommend tuning to a user.

For example, a competitor price index may be used in the optimization and in generation of a tuning indicator. A competitor price index is a normalized index of competitor prices on a set of items sold at a set of locations in relation to those provided by the plan, using competitor price data that is provided through various services. As a specific example, a user might define a competitor price index on all brands and sizes of paper towels sold at stores with a WalMart located less than five miles away (the identification of WalMart locations may be done outside the system). An indicator can then be provided to identify when prices provided by the plan exceed a competitor price index of 105—in other words when they are above the competitor's prices by more than 5% on some subset of items (in the case above, when WalMart has lowered paper towel prices, resulting in a change to that competitor price index relative to the plan). In another example, costs are always changing. It is usually undesirable to change prices immediately every time costs change. Therefore, in another example, the system provides a tuning recommendation when either small cost changes cause an aggregate change of more than 5% or a single cost change causes a cost change of more than 3%. Therefore, the tuning indicators are based on formulas that measure either changes in individual data or changes in relationships between values of the data.

In viewing the re-predicted outcome and the tuning recommendation, the planner 117 is able to have the processing system 103 tune the plan (step 264). The planner 117 may then send out a message to implement the tuned plan (step 248). A single screen may show both the information that the planner needs to use to make a decision and provide a button to allow the planner to implement a decision. The button may also allow tuning on demand, whenever desired by the user.

This process allows for a long term plan to be corrected over the short term. This allows for corrections if the long term plan has an error, which in the short term may be less significant, but over the long term may be more significant. In addition, current events may change the accuracy of a long term model. Such current events may be a change in the economy or a natural disaster. Such events may make a six-month plan using data from the previous year less accurate. The ability to tune the plan on at least a weekly basis with data from the previous week makes the plan more responsive to current events.

In addition, the optimization system provides a promotional plan that plans and schedules product pricing markdowns and other promotions. Without the optimization system, poor-performing promotions may go unidentified until it is too late to make changes that materially affect their performance. The use of constant updates helps to recognize if such a plan creates business problems and also allows a short term tuning to avoid further damage. For example, a promotion plan may predict that a discount coupon for a particular product for a particular week will increase sales of the product by 50%. A weekly update will within a week determine the accuracy of the prediction and will allow a tuning of the plan if the prediction is significantly off.

The system may provide that if a long term plan is accurate within a certain percentage, the long term plan is not changed. In such an embodiment, the system may allow an automatic tuning when a long term plan is not accurate within a certain percentage. In another embodiment, the planner may be allowed to decide whether the long term plan is in enough agreement with the updated data so that the long term plan is kept without tuning.

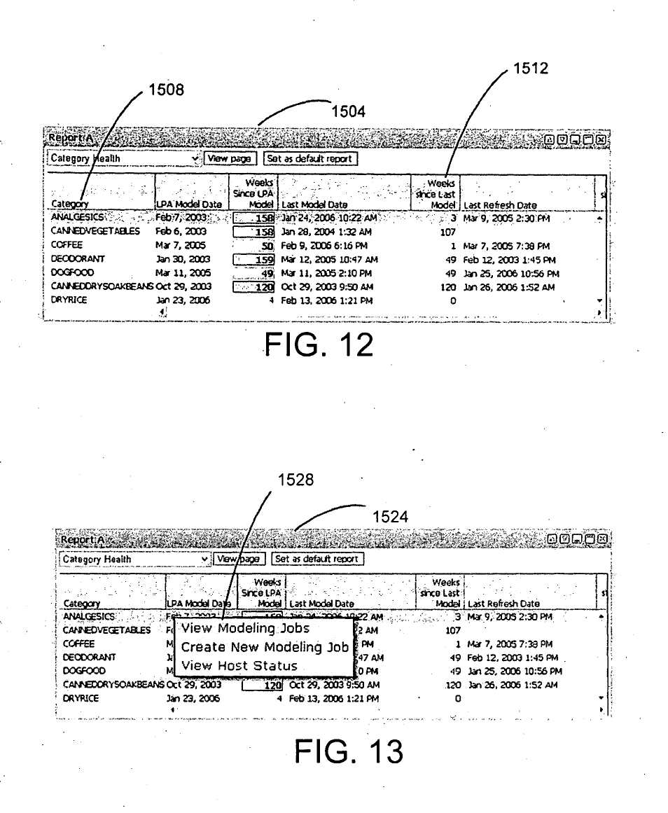

FIG. 12 is a screen shot 1504 that shows a simple indicator of “model health” for various product categories 1508 based on time since the last full model 1512. Other ancillary information on updates is also provided.

FIG. 13 is a screen shot 1524 that shows the screen shot of FIG. 12, but with a right-click menu 1528 that enables a user to start a new modeling job directly from the screen of “model health” indicators.

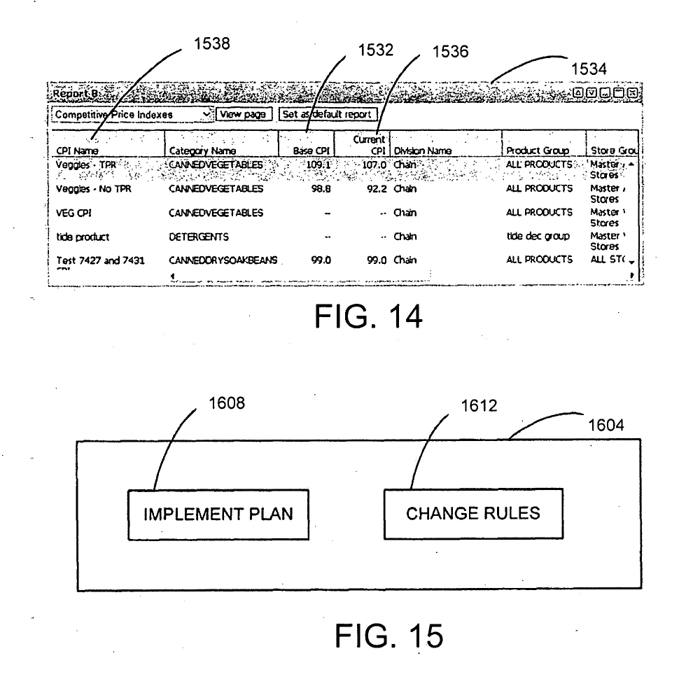

FIG. 14 is a screen shot 1534 that shows the values of several competitor price indices, the product set to which the indices apply 1538, the target base threshold value set for the index 1532, and the current value of the index 1536, derived from plan prices and actual competitor price data.

FIG. 15 is a schematic illustration of part of a screen 1604 that shows an option of implementing a tuned plan 1608 or further tuning a plan by changing the rules 1612.

Thus, the invention allows the integration between the operational system of a business, which sets prices and promotions and performs other sales or business functions, with the analytical system of a business which looks at sales or other performance information, to allow a planner to receive timely analytical information and then change the operational system and then to quickly, through the analytical system, see the results of the change in the operational system to determine if other changes in the operational system need to be made.

Such a constant tuning of a plan is made difficult by the large amount of data that needs to be processed and the complexity of the processing, which could take weeks to process or would be too expensive to process to make such tuning profitable. Therefore, the invention provides the ability to process large amounts of data with the required complexity quickly and inexpensively enough to provide weekly or daily tuning. A balance is made between the benefit of more frequent tuning and the cost and time involved for tuning, so that the tuning is done at a frequency where the benefit from tuning is greater than the cost of tuning at the desired frequency.

In addition, the sales data that is to be updated arrives as a set of records organized by time, product, and location—a data flow. The numeric operations that synthesize demand coefficients are performed as matrix operations, and require their inputs to be in a very specific format—one much different from the format in which the raw customer data arrives. One choke point that slows such operations is transforming customer data so that numerical matrix operations may be performed on the data.

For this purpose, the above inventive system uses data flow processing to transform input data into matrices that are partially in memory and partially on disk at any given time. Matrices are saved wholly on disk and references to the matrices are passed to numerical functions, which process the matrices. The numeric functions process the matrices to provide output data sets, which are kept partially on disk and partially in memory. Upstream data flow processing must complete a matrix before the matrix may be processed by a numerical function.

In addition to matrix processing, there are numerous other numerical functions that operate on different types of structures, including vectors, and tabular data. The data flow processing mechanism allows raw input data to be transformed into the appropriate structure for input to any numerical function, and allows the outputs of those functions to be further transformed as inputs to downstream functions.

Data flow transformations and numeric functions may not always read data row by row. Reading large amount of data from a disk in a nonsequential manner is time intensive and may create another choke point. The invention provides the using of parallel readers, the creating of smaller data subsets, and the processing of data while part of the data is in memory and part of the data is on disk to avoid the time intensive data reading process.

For a six-month plan, a weekly analysis could allow the tuning of the plan up to 26 times. Preferably, the plan is tuned at least 15 times. More preferably, the plan is tuned at least 6 times. In other embodiments, the tuning may be done on a daily basis.

Data 120 is provided to the processing system 103. The data 120 may be raw data generated from cash register data, which may be generated by scanners used at the cash registers, this Data 120 is known as Point of Sale (POS) data. The first data transformation engine 101 and the second data transformation engine 102 format the data so that it is usable in the econometric engine and financial model engine. Some data cleansing, such as removing duplicate entries, may be performed by the first and second data transformation engine 101, 102.

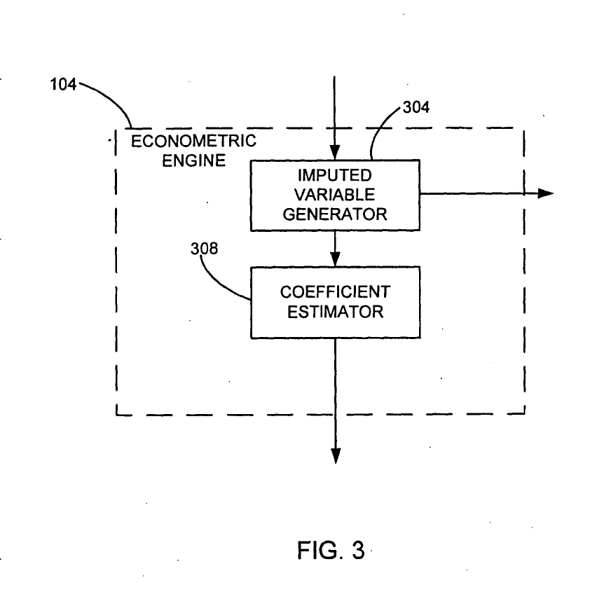

FIG. 3 is a more detailed view of the econometric engine 104. The econometric engine comprises an imputed variable generator 304 and a coefficient estimator 308. The formatted data from the first data transformation engine 101 is provided to the imputed variable generator 304. The imputed variable generator 304 generates a plurality of imputed econometric variables.

III. System Architecture

FIG. 12 is a schematic view of a computer architecture 1300 that is able to provide the processing of the large dataflow. The architecture 1300 provides a data flow and numerics core module 1304, modeling and optimization services module 1308, and application components module 1312. A first interface 1306 connects the data flow and numerics core module 1304 to the modeling and optimization services module 1308. A second interface 1342 connects the data flow and numerics core module 1304 to the data flow and numerics applications 1344. A third interface 1310 connects the modeling and optimization services module 1308 to the applications components module 1312. A fourth interface 1338 connects the modeling and optimization services module to the modeling and optimizations vertical applications module 1340. A fifth interface 1314 connects the applications components module 1312 to three retail application modules for price 1316, promotions 1320, and mark down 1324. A sixth interface 1326 connects the application components module 1312 to three consumer package goods modules (CPG) for sales 1328, marketing 1332, and other various applications 1336. The retail applications and the CPG applications are supported by the applications components module 1312.

The data flow and numerics core 1304 processes large amounts of data and performs numerical operations on the data. An embodiment of the dataflow and numerics core 1304 that provides economic processing is an Econometric Data Transformation and Synthesis Engine (EDTSE). The dataflow and numeric core 1304 forms a combination of ETL (Extract/Transform/Load), which is a data processing term and numerical analytics). The data flow and numerics core 1304 is able to perform complex mathematical operations on large amounts of data. The modeling and optimization services 1308 may be a configurable optimization engine. The applications component 1312 supports applications.

The modeling and optimization vertical applications module 1340 provides applications that are vertical applications supported directly by the modeling and optimization services module 1308. Such applications may be applications for modeling oil and gas well optimization, and financial services portfolio optimization, retail price optimization, and other applications that can be described by a mathematical model, which can be modeled and optimized using the platform. The data flow and numeric applications module 1344 provides vertical applications that are supported directly by the data flow and numerics core module 1304.

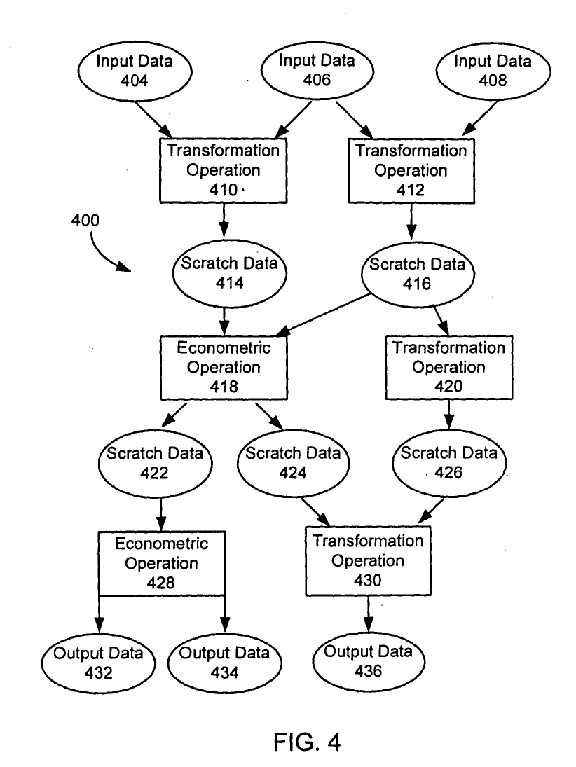

FIG. 4 is a schematic illustration of an example of a flow through 400 of an Econometric Data Transformation and Synthesis Engine (EDTSE). The engine consists of a set of transformation and econometric functions that can be combined/composed into higher-level econometric transformation and synthesis functions using a scripting mechanism. Other flows may be run serially or in parallel on other computers of a network.

The EDTSE allows the creation of complex econometric data outputs by breaking down the problem into a graph of operations on intermediate data sets. The EDTSE then executes this graph, allowing independent nodes to run simultaneously and sequencing dependent node execution. EDTSE graphs partition the data as well, allowing multiple subsets of data to be processed in parallel by those operations that have no intra-dataset dependencies.

This example illustrates the types of top-level operations performed by the EDTSE. All operations may accept multiple inputs and may produce multiple outputs. Operations fall into two primary types: Transformation Operations and Econometric Operations.

Transformation Operations change the structure of the input data set, but do not synthesize new information. These transformations may be simple from a structural perspective (such as filtering to removing selected elements) or may be complex from a structural perspective (such as partial transposition and extraction of non-transposed values in a different format).

Econometric Operations synthesize new values from one or more input data sets, and produce new output data sets from them. As with Transformation Operations, there is a range of complexity. Examples of Econometric Operations include missing value imputation, outlier detection and culling, etc.

Data provided to the EDTSE 400 may be provided by a first input data 404, a second input data 406, and a third input data 408, which may provide different types of data. For example, the first input data 404 may be point-of-sale input data, the second input data 406 may be cost data, and the third input data 408 may be product data. A first transformation operation 410 receives the first input data 404 and the second input data 406. A second transformation operation 412 receives the second input data 406 and the third input data 408. The first and second transformation operations 410, 412 perform transformation operations generally related to changing the structure, content, and format of the data. Such transformation operations do not perform complex mathematical operations to synthesize new information. Output from the first transformation operation 410 is stored as a first scratch data 414 as a first temporary file. Output from the second transformation operation 412 is stored as a second scratch data 416 as a second temporary file.

A first econometric operation 418 receives data from the first scratch data 414 and the second scratch data 416 and performs at least one mathematical operation on the data to synthesize new data, which is outputted as third scratch data 422 in a third temporary file and fourth scratch data 424 in a fourth temporary file. The mathematical operation may be at least one of a matrix operation, such as matrix inversion, transposition, multiplication, addition, subtraction, and arithmetic operations. In addition, it may perform extremely complex numerical algorithms that use matrices as their inputs and outputs; for example, regression analysis with a mix of linear and non-linear variables. In this example, the first econometric operation 418 is performed in parallel with a third transformation operation 420 which receives as input the third scratch data 416, performs transformational operations on the third scratch data, and then outputs fifth scratch data 426 in a fifth temporary file.

In this example, a second econometric operation 428 receives as input the third scratch data 422, performs mathematical operations on the third scratch data to synthesize new data, which is outputted as first output data 432 and second output data 434. One example of new data would be the generation of demand coefficients 128. The fourth transitional operation 430 receives as input the fourth scratch data 424 and the fifth scratch data 426, performs transformational operations, and outputs a third output data 436. Preferably, the first, second, and third output data 432, 434, 436 are stored on a shared storage.

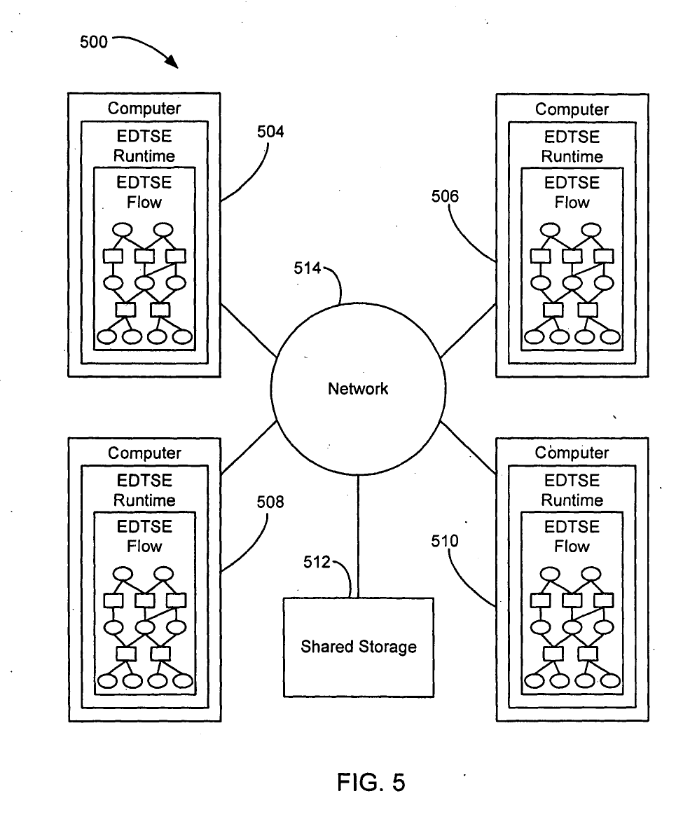

FIG. 5 is a schematic view of a computer network 500, provided by an embodiment of the invention. In this embodiment, the computer network comprises a first, second, third, and fourth computer 504, 506, 508, 510, a shared storage 512, and a network 514 connected between the computers 504, 506, 508, 510, and the shared storage 512. In this example, on each computer 504, 506, 508, 510 is computer readable media with computer readable code for the EDTSE. In this example, each computer 504, 506, 508, 510 is running the EDTSE code in an EDTSE run time. EDTSE flows are running in the EDTSE run time. The EDTSE runtime requests for data flows on particular data sets are dispatched. Each runtime instance can execute an EDTSE flow on a dataset or a portion thereof, consuming the appropriate inputs and producing its part of the final output dataset, which is streamed in parallel to its final repository. The EDTSE flows can be executed on a single computer or across multiple computers.

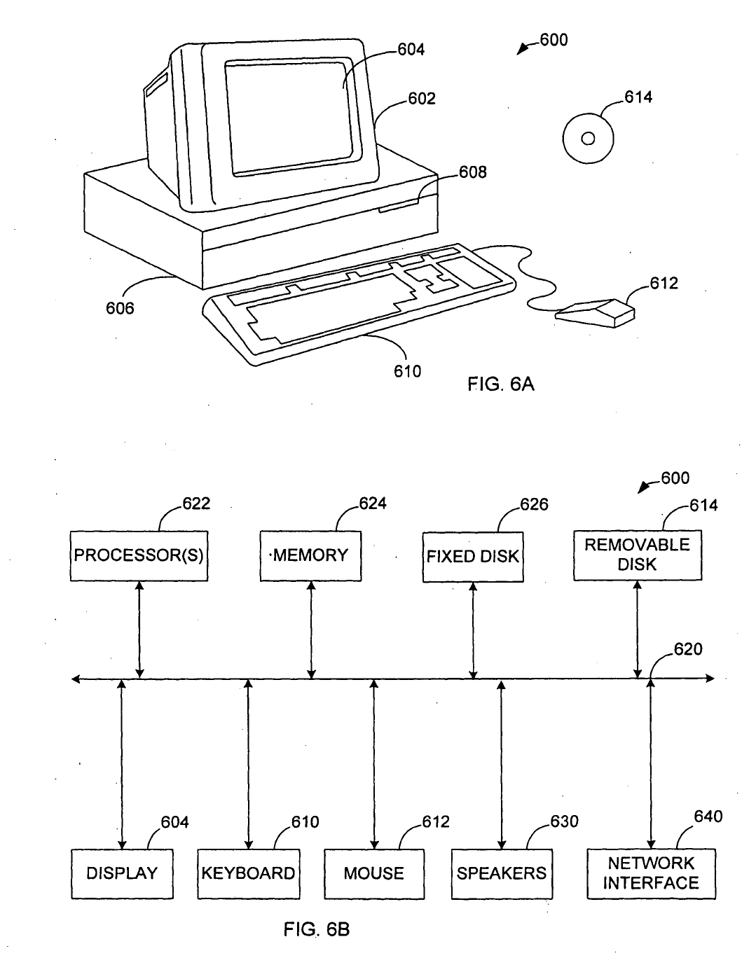

FIGS. 6A and 6B illustrate a computer system 600, which may be any of the computer systems 504, 506, 508, 510 and is suitable for implementing embodiments of the present invention. FIG. 6A shows one possible physical form of the computer system. Of course, the computer system may have many physical forms ranging from an integrated circuit, a printed circuit board, and a small handheld device up to a huge super computer. Computer system 600 includes a monitor 602, a display 604, a housing 606, a disk drive 608, a keyboard 610, and a mouse 612. Disk 614 is a computer-readable medium used to transfer data to and from computer system 600.

FIG. 6B is an example of a block diagram for computer system 600. Attached to system bus 620 is a wide variety of subsystems. Processor(s) 622 (also referred to as central processing units, or CPUs) are coupled to storage devices, including memory 624. Memory 624 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 626 is also coupled bi-directionally to CPU 622; it provides additional data storage capacity and may also include any of the computer-readable media described below. Fixed disk 626 may be used to store programs, data, and the like and is typically a secondary storage medium (such as a hard disk) that is slower than primary storage. It will be appreciated that the information retained within fixed disk 626 may, in appropriate cases, be incorporated in standard fashion as virtual memory in memory 624. Removable disk 614 may take the form of any of the computer-readable media described below.

CPU 622 is also coupled to a variety of input/output devices, such as display 604, keyboard 610, mouse 612, and speakers 630. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 622 optionally may be coupled to another computer or telecommunications network using network interface 640. With such a network interface, it is contemplated that the CPU might receive information from the network, or might output information to the network in the course of performing the above-described method steps. Furthermore, method embodiments of the present invention may execute solely upon CPU 622 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter. Computer readable media may also be computer code transmitted by a computer data signal embodied in a carrier wave and representing a sequence of instructions that are executable by a processor.

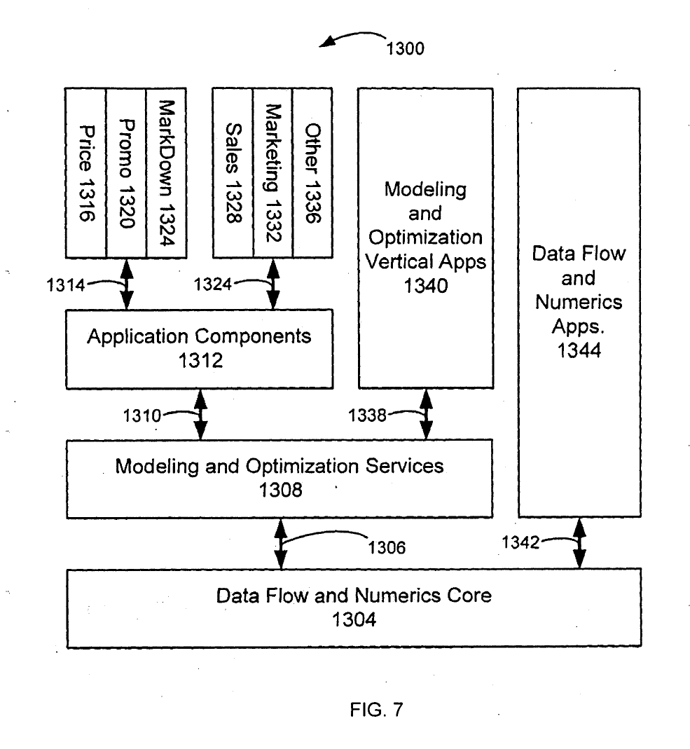

FIG. 7 illustrates composition of EDTSE flow and flow segments in general. Individual EDTSE operations are composed into flow segments, which stream a set of operations in parallel. The smallest possible flow is one flow segment. FIG. 7 also illustrates the way that EDTSE flows can operate in parallel across partitioned data sets.

The EDTSE flow segment 700 in FIG. 7 comprises a first input 702, a second input 704, a third input 706, and a fourth input 707. A first EDTSE flow 708 receives the first input data 702, the second input data 704, and third input data 706, and provides a first scratch data set 712, comprising a plurality of scratch data. In this example, the EDTSE flow 400 in FIG. 4 is the first EDTSE flow 708. A second EDTSE flow 710 receives data from the third input data 706 and the fourth input data 707 and outputs a second scratch data set 714, comprising a plurality of scratch data.

A first set of EDTSE flows 716 may be a plurality of EDTSE flows with each EDTSE flow running on a different computer on the network 500. A second set of EDTSE flows 718 may be a plurality of EDTSE flows with each EDTSE flow running on a different computer on the network 500. Each scratch data of the first scratch data set 712 and each scratch data of the second scratch data set 714 are used to signal a computer running an EDTSE flow of the first set EDTSE flows 716 to cause the EDTSE flow to process scratch data from the first scratch data set 712 and scratch data from the second scratch data set 714. For example, a first scratch data from the first scratch data set 712 and a first scratch data from the second scratch data set 714 may be used to signal a computer running a first EDTSE flow of the first set of EDTSE flows 716 on a first computer, which processes the first scratch data from the first scratch data set 712 and the first scratch data from the second scratch data set 714 and outputs a first scratch data of a third scratch data set 720 and a first scratch data of a fourth scratch data set 724. A second scratch data from the first scratch data set 712 and a second scratch data from the second scratch data set 714 may be used to signal a computer running a second EDTSE flow of the first set of EDTSE flows 716 on a second computer, which processes the second scratch data from the first scratch data set 712 and the second scratch data from the second scratch data set 714 and outputs a second scratch data of a third scratch data set 720 and a second scratch data of a fourth scratch data set 724. A third scratch data from the first scratch data set 712 and a third scratch data from the second scratch data set 714 may be used to signal a computer running a third EDTSE flow of the first set of EDTSE flows 716 on a third computer, which processes the third scratch data from the first scratch data set 712 and the third scratch data from the second scratch data set 714 and outputs a third scratch data of a third scratch data set 720 and a third scratch data of a fourth scratch data set 724.

In a similar manner the second set of EDTSE flows 718 takes input from the second scratch data set 714 and in a parallel manner produces a fifth scratch data set 726.

The third scratch data set 720 is inputted into a third EDTSE flow 728 to produce a first output data 732. The fourth scratch data set 724 and the fifth scratch data set 726 are inputted into a fourth EDTSE flow 730 to produce a second output data 734. The third EDTSE flow 728 and fourth EDTSE flows 730 are examples of how data sets created in parallel may be consolidated into a final form.

This example illustrates how the invention allows for a scalable process using parallel flows. Because of the scalability of this platform, the platform may be run on a single laptop computer or on a large network of computers with several racks of servers.

Flows can be made parallel either along the process domain, the data domain, or both. In both of these domains, the parallelization can be either implicit, explicit, or both.

The creator of a flow may also choose to make explicit choices about how to partition along the process domain. For example, in an implementation that uses a network of computers to solve large problems, the creator of a flow may choose to mark specific subflows as being of appropriate granularity for separate execution on a distinct computer. The system can then distribute the execution of those subflows across the network of computers. Within each individual computer, the subflow remains implicitly parallel along the process domain, meaning that any operations within it that accept the same inputs (or whose inputs simply do not depend on each other) can be executed in parallel. Flows can also be made parallel along the data domain. This can be done either explicitly or implicitly. Implicit data partitioning is performed by the system itself.

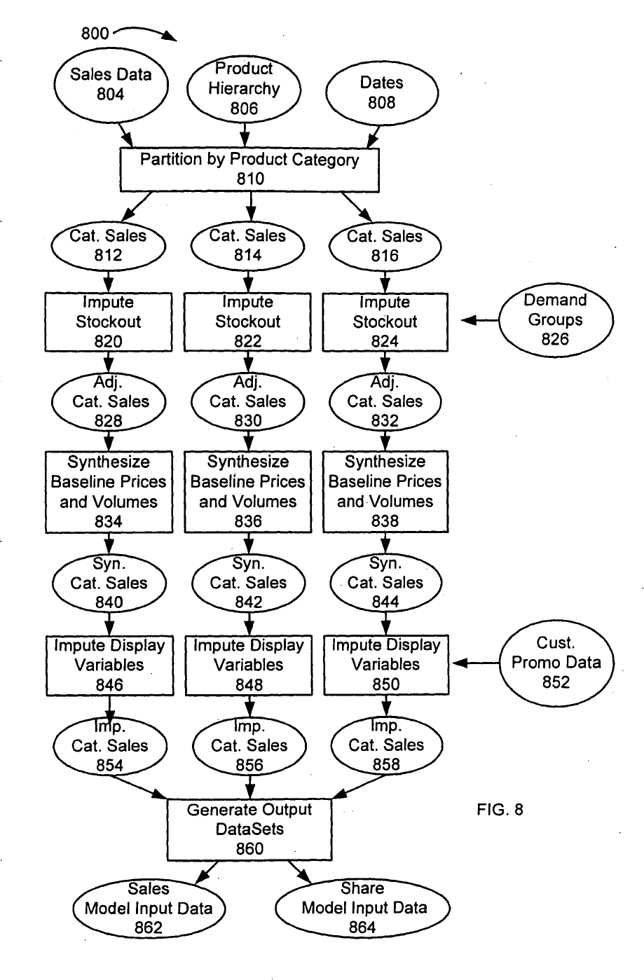

FIG. 8 provides a specific example 800 of EDTSE flow and flow segments used for an imputed variable generator. Three different kinds of input data are provided: sales data 804, product hierarchy 806, and dates 808. The sales data 804 provides sales data that may be partitioned by store, product, and week. The product hierarchy data 806 provides information on how products are categorized. The date data 808 provides the specific dates or date ranges for which information is desired. A partition by product category process 810 partitions the input data into subsets, which group the sales data by category and date. In the example shown in FIG. 8, the input data is partitioned into a first category sales subset 812, a second category sales subset 814, and a third category sales subset 816.

A first impute stockout process 820 receives as input the first category sales subset 812 and provides as output a first stock out adjusted category sales subset 828. A second impute stockout process 822 receives as input the second category sales subset 814 and provides as output a second stock out adjusted category sales subset 830. A third impute stockout process 824 receives as input the third category sales subset 816 and provides as output a third stock out adjusted category sales subset 832.

An imputed stockout process reviews entries where no items were sold and determines whether this was caused by the item being out of stock. If it is determined an item is out of stock, an adjustment is made in the data. This may be done by providing a flag to indicate that there was a stock out. The imputed stock out process requires a mathematical operation that analyzes sales of related items for a series of weeks to determine if a stock out occurred and a transformational operation that flags stock out events. Demand group data 826 may also be provided as input to the first, second, and third imputed stockout processes 820, 822, 824, since sales of other items in the same demand group as the item being checked for stockout are used see the demand for other items in the same demand group. If the demand for other items in the demand group was normal, that would help to indicate that lack of sales of the item was due to stock out.

Demand groups are groups of highly substitutable products as perceived by buyers, such as different sizes or brands of the same product or alternative products, but not limited to these attributes.

A first synthesize baseline prices and volumes process 834 receives as input the first stock out adjusted category sales subset 828 and provides as output a first synthesized category sales subset 840. A second synthesize baseline prices and volumes process 836 receives as input the second stock out adjusted category sales subset 830 and provides as output a second synthesized category sales subset 842. A third synthesize baseline prices and volumes process 838 receives as input the third stock out adjusted category sales subset 832 and provides as output a third synthesized category sales subset 844.

The synthesize baseline prices and volume processes impute normalized values for base price and base sales volume by examining the time series of sales for a given product/location and mathematically factoring out promotional, seasonal, and other effects. For example, baseline sales volume represents the amount of a product that would sell in a truly normal week, excluding promotional, seasonal, and all other related factors. This value may never appear in the actual sales data. It is strictly a mathematical construct. Base price similarly represents a normalized baseline sale price for a given item/location combination, excluding promotional and any other factors that affect a product's sale price.

A first imputed display variables process 846 receives as input the first synthesized category sales subset 840 and provides as output a first imputed category sales subset 854. A second imputed display variables process 848 receives as input the second synthesized category sales subset 842 and provides as output a second imputed category sales subset 856. A third imputed display variables process 850 receives as input the third synthesized category sales subset 844 and provides as output a third imputed category sales subset 858. Customer promotional sales data 852 may also be provided as input to the first, second, and third imputed display variable processes 846, 848, 850.

Customer promotional data is data which provides a promotional program for particular items, such as in-store promotional displays. Even though a chain may schedule a promotional display in all stores, some stores may not comply and not carry the promotional display. The impute display variables process measures sales data to determine whether a store actually had a promotional display as indicated by the customer promotional data. If it is determined that a store did not actually have a display, then the customer promotional data may be changed accordingly. In addition, if other types of promotion, such as a flyer, are being used concurrently with a promotional display, an imputed display variables process can determine whether a change in sales is due to the promotional display or other type of promotion.

A generate output datasets process 860 combines the parallel flow outputs of the first, second, and third imputed category sales subsets 854, 856, 858 and provides a first and second sales model input data sets 862, 864. The data is eventually provided to the econometric engine. Additional imputed variable generation steps may be performed before the data is provided to the econometric engine.

In the preferred embodiment, an entire flow for an entire program is put on every computer. The network controls can be used to set which computers on the network perform which part of the entire flow. In another embodiment, different flow segments may be placed on different computers. Output from one flow segment on one computer may then be sent to a subsequent flow segment on another computer.

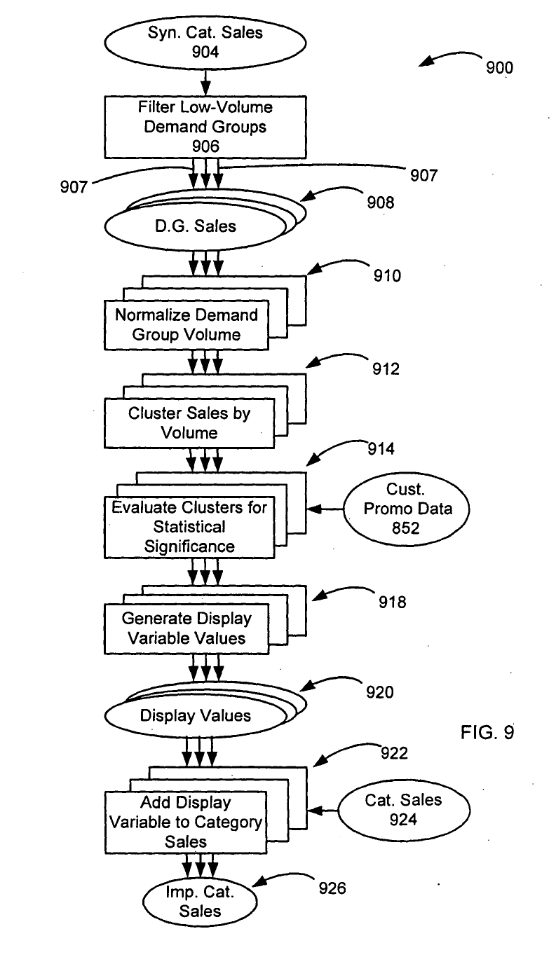

FIG. 9 is a more detailed flow 900 of any of the first, second, and third imputed display variable processes 846, 848, 850. A synthesized category sales subset 904 is provided as input into a low volume demand group filter 906, which filters low volume demand groups and divides sales according to demand groups to produce a plurality of demand group sales subset data 908. The low volume demand groups are filtered out because if sales volume of the demand group is low, the signal to noise ratio is low, which makes such data unusable because the data may cause more error. In flow 800, the sales data was split by category across different computers. Here data is further split according to demand group across the different threads, allowing additional granularity.

Threads 907 are used so that each thread processes a normalize demand group volume process of a set of normalize demand group volume processes 910. The normalize demand group volume processes normalize the demand group volumes between zero and one. Each thread then processes a cluster by sales volume process of a set of cluster by sales volume processes 912. The cluster by sales volume processes finds clusters of data and groups them together.

Each thread then processes an evaluate cluster for statistical significance processes of a set of evaluate clusters for statistical significance processes 914. If sales volume fluctuates from one cluster to another randomly, it may be deemed noise and ignored. If sales volume is in one cluster for several weeks and then in another cluster for several weeks, that may be deemed statistically significant and therefore is not ignored. In addition, the evaluate clusters for statistical significance processes may use customer promotional data 852 to determine if customer promotions are related to the clusters.

Each thread then processes a generate display variable values process of a set of generate display variable values processes 918. The generate display variable values processes generate a set of display variable values 920 to indicate whether or not a cluster is significant. In this example, if the clusters are significant then a value of one is assigned as a display variable and if the clusters are not significant then a value of zero is assigned as a display variable.

Each thread then processes an add display variable to category sales process of a set of add display variable category sales processes 922. The add display variable to category sales processes receive as input the display values and category sales 924 and output imputed category sales 926. The add display variable to category sales processes are pure transformational operation since it takes an existing data set and creates a new value that applies to all of the items in the data set. Data that is generated to determine the imputed display variables by this flow may be discarded.

Although each of the first, second, and third imputed display variable processes 846, 848, 850 are run on a separate computer, a computer running the first imputed display variable process 846 may provide parallel processing by dividing of the first imputed display variable process 846 into multiple threads. While in this example all of the threads are run on a single computer, in an alternative embodiment each thread could be run on a different computer.

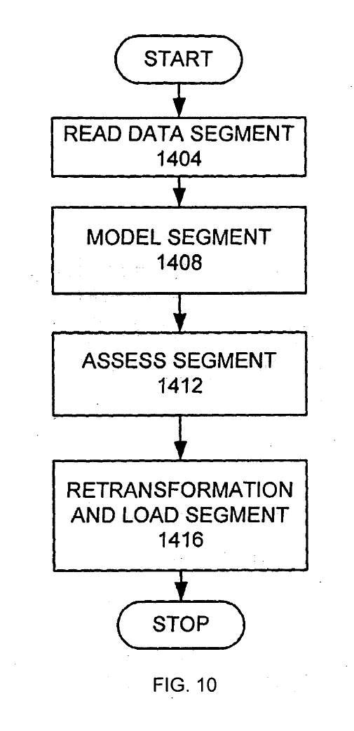

FIG. 10 is a flow 1000 that illustrates a process of going from a single input data set 1004 to multiple parallel processes, which process the input data set in parallel and then yield a single output data set 1016. The input data set 1004 is read by a parallel reader 1006. The parallel reader 1006 reads from multiple places in the data set 1004 and feeds different data from different locations to different flow segments of a first set of flow segments 1008. For example, for a file with thirty records if there are three parallel flows, ten records may be provided to each of the three parallel flows. In this example, the file is on a disk. The parallel reader 1006 knows the structure of the file of the input data set 1004. From the structure of the file, the parallel reader 1006 is able to take data from various parts of the file, in a nonsequential manner, and send different data to different flow segments of the first set of flow segments 1008 allowing the first set of flow segments to operate in parallel. This may be implemented by putting different data in different buffers. When a flow segment of the set of flow segments 1008 sees that a buffer is filled, the flow segment processes the data in the buffer and outputs the data into a second buffer as intermediate data. The operation of the parallel reader 1006 allows data to be read in parallel, which speeds up the reading of data from a disk, which might otherwise cause a bottleneck. The first set of flow segments creates a set of intermediate data sets 1010, which is provided as input to a second set of flow segments 1012. The second set of flow segments 1012 processes the intermediate data sets 1010 and provides output to a parallel writer 1014, which saves the output of the parallel flows in a file on a disk as an output data set 1016.

The flow 1000 therefore acts as a bucket brigade. To avoid a bottle neck, the parallel reader 1006 may be able to take data from a disk for multiple flow segments 1008 in a single seek operation, because the parallel reader 1006 knows the structure of the data files of the input data set 1004 and may put the data for each different flow segment in a different buffer, which is analogous to taking three buckets and filling them with water at the same time and then making each bucket available to a different recipient, so that the recipients may act in parallel. Acting as state machines, when a buffer for a flow segment of the first set of flow segments 1008 is filled, the flow segment acts on the data in the buffer and then outputs to a second buffer the intermediate data for the intermediate data set 1010. Acting as state machines when second buffers for the flow segments for the second set of flow segments 1012 are filled, the flow segments of the second set of flow segments 1012 operate on the intermediate data in the buffer and provide output to the parallel writer 1014. The parallel writer 1014 is able to combine the data from the second set of flows 1012 into a file on a disk as the output data set 1016. This would be analogous to passing buckets from first recipients, the first set of flow segments 1008, to second recipients, the second set of flow segments 1012, which pass it to a common place, the parallel writer 1014, which is able to dump all three buckets into a single location. As mentioned above, the parallel processing may be where each parallel flow is run on a different computer or a different thread on the same computer.

FIG. 13 is a flow chart that illustrates high level econometric modeling operations (executable segments along the process domain), which provides coarse granularity for generating an econometric engine. A first econometric operation is a read data segment 1404. The read data segment 1404 performs data cleansing, such as checking the data to make sure that data is present, formatted in a usable form and providing imputed variables and display variables. A second econometric operation is a model segment 1408. The model segment 1408 performs matrix-solving operations to generate demand coefficients for creating an econometric model. A third econometric operation is an assess segment 1412. The assess segment 1412 checks the demand coefficients and provides metrics that indicate the statistical fit of the model generated by the demand coefficients. A fourth econometric operation is a transformation and load segment 1416. The transformation and load segment 1416 transforms and loads the demand coefficients back into the database for use in the econometric engine.

Each of these high level econometric operations may each be broken into smaller econometric operations. For example, the read data segment 1404 may be broken into its constituent data flow and econometric operations. A simplified description of this process for the read data segment is provided in FIG. 8 and its accompanying text. One step within that process is further decomposed in FIG. 9 and its accompanying text. This process of successive composition illustrates an example of the way an extremely complex process on a large volume of data can be structured and subsequently executed in parallel.

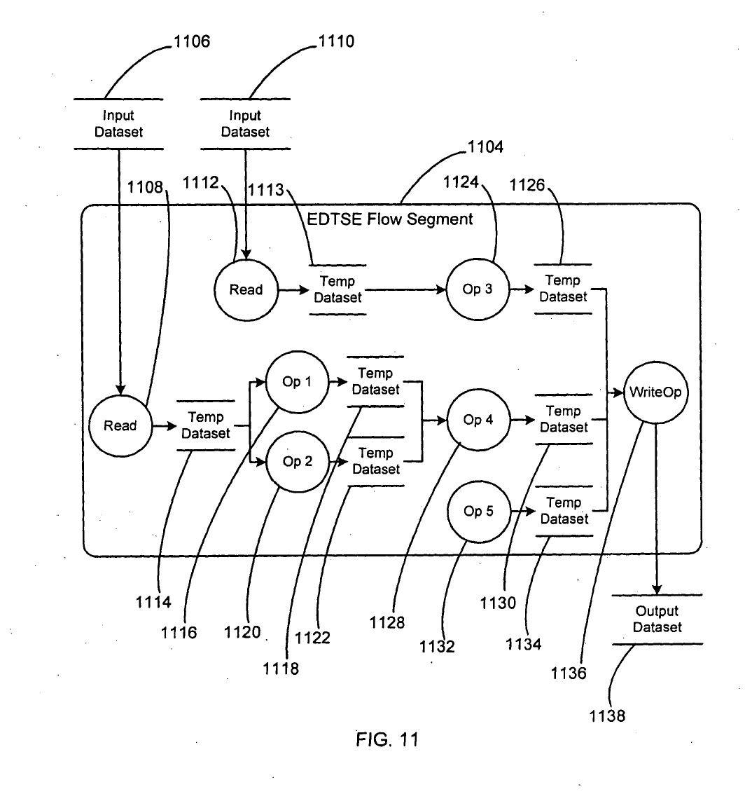

FIG. 11 is a schematic illustration of an internal structure of an EDTSE flow segment 1104 at run time. A first input dataset 1106 is subjected to a first read operation 1108. A second input dataset 1110 is subjected to a second read operation 1112. Data read by the first read operation 1108 is stored in a first temporary dataset 1114, such as a first buffer. In parallel, data read by the second read operation 1112 is stored in a second temporary dataset 1113, such as a second buffer. A first operation 1116 uses data in the first temporary data set 1114 and outputs data to a third temporary data set 1118. A second operation 1120 uses data in the first temporary dataset 1114 and outputs data to a fourth temporary dataset 1122. In parallel, a third operation 1124 uses data in the second temporary dataset 1113 and outputs data to a fifth temporary dataset 1126. A fourth operation 1128 uses data in the third temporary dataset 1118 and outputs data into a sixth temporary dataset 1130. A fifth operation 1132 outputs to a seventh temporary dataset 1134. A write operation 1136 takes data from the fifth temporary dataset 1126, the sixth temporary data set 1130, and the seventh temporary dataset 1134 and writes it to an output dataset 1138. Generally, a flow segment is a set of processing nodes and arcs between processing nodes that represent what goes into a processing node and what goes out of a processing node.

The operations are examples of various kinds of operations, such as using a single dataset to provide another single dataset, the first, second, and third operations 1116, 1120, 1124. The fourth operation 1128 combines two datasets to obtain a single dataset. The fifth operation 1132 does not have any input data but generates data. An example of such an operation would be a timestamp.

The ability to provide updating using large amounts of data and complex operations, which may be used for demand modeling, may also be used in ad or display performance modeling, brand management, supply chain modeling, financial services such as portfolio management, and even in seemingly-unrelated areas such as capacity optimization for airline or shipping industries, yield optimization for geological or oil/gas industries, network optimization for voice/data or other types of network.

Since the segment flows are created to automatically process data when data is received, the platform provides a more automated process. Such a process is considered an operations process instead of an ad hoc process, which may require a user to receive data and then initiate a program to process the received data to produce output data and then possibly initiate another program to process the output data. The user can configure the system to perform processes automatically as new data arrives, or to set thresholds and other rules so that users can be notified automatically about changes or processes for which they desire human or other approval.

The invention provides a system that is able to quickly process large amounts of sales data to generate resulting distilled and comprehendible information to a user (planner) in real time at the moment the user needs to make a decision and then the system allows the user to make a decision and implement the decision.

IV. System for Pricing Markdowns with Reoptimization

A Senior Buyer, or user, may have multiple sets of products on markdown over different sets of stores. Each combination of products and stores may be at different points in their respective markdown plans, but nonetheless, the buyer will often monitor the performance of all products under his purview at the same time. Typically this happens on a weekly basis and consists of measuring the actual performance and comparing it against forecasted performance. Besides measuring performance of the products on markdown, users also keep tabs on the status of the replacement products and whether they are on schedule to arrive as planned. If actual sales and the forecasted sales are wildly at odds or if the replacement dates for products change, the buyer may take several corrective actions.

For example, if the actual sales are considerably worse than expected the user may choose to accelerate the timing of the next planed markdown and increase the depth of the current markdown. These changes may occur at the product-store level, or at any higher level as deemed acceptable by corporate guidelines.

If the actual sales are higher than forecasted, then the user may choose to delay the next planned markdown. In some cases, users may order extra inventory to meet demand for the product. Although this appears to be counter-intuitive to the stated purpose of markdown pricing, which is to remove products from the assortment, such steps are sometimes necessary since exiting too quickly may lead to thin assortment and narrow consumer choice in the period before the replacement products arrive.

If the arrival date for replacement dates moves forward by a few days, or weeks, the inventory of the incoming products will build up rapidly, and therefore the user may choose to accelerate the markdown of the obsolete product by bringing the out-date forward and by decreasing the price.

Conversely, if the replacement date for an incoming product is delayed, user may choose to slow down the markdown cycle for the existing product so that stores have sufficient assortment choice until the new product arrives.

In a typical retail setting, the user may be responsible for anywhere from 5-10 products on markdown to over 500 at any one time.

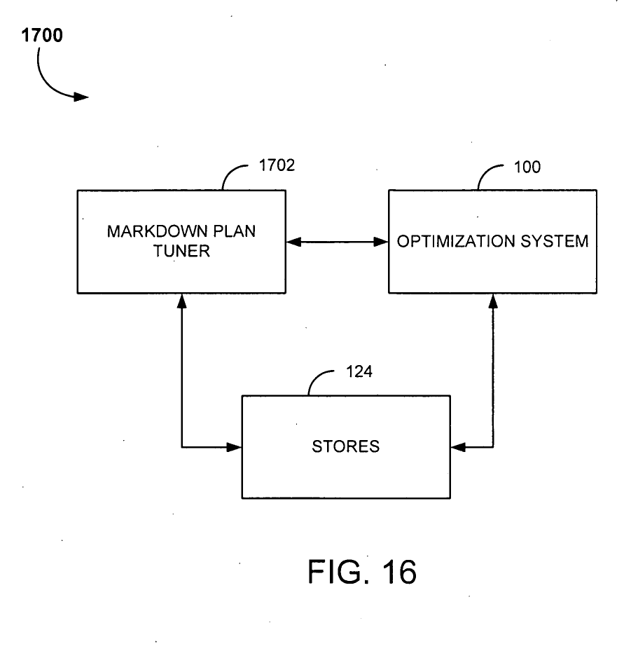

FIG. 16 shows an exemplary block diagram for the system for markdown plan generation and reoptimization, shown generally at 1700. A Markdown Plan Tuner 1702 couples to the Optimization System 100 and Stores 124. Likewise, in some embodiments, the Stores 124 may also couple with the Optimization System 100.

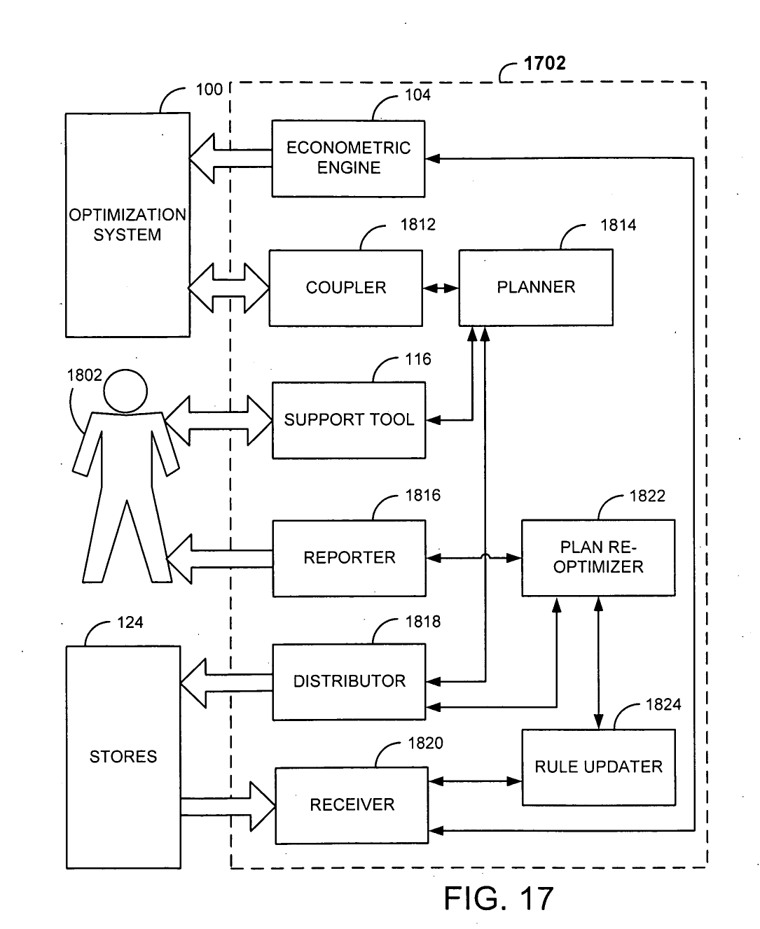

FIG. 17 shows an exemplary block diagram for the Markdown Plan Tuner 1702 of FIG. 16. Here the Markdown Plan Tuner 1702 couples to the Optimization System 100, a User 1802 and the Stores 124. Markdown Plan Tuner 1702 may, in some embodiments, include the Econometric Engine 104, the Support Tool 116, a Coupler 1812, a Planner 1814, a Reporter 1816, a Distributor 1818, a Receiver 1820, a Plan Re-optimizer 1822 and a Rule Updater 1824.

The Econometric Engine 104 may generate demand coefficients for the products using past sales data, or estimates generated from industry standards. These demand coefficients may be provided to the Optimization System 100 for generation of optimizations for the products pricing. The Optimization System 100 may then supply the pricing optimizations to the Planner 1814 via the Coupler 1812.

The User 1802 may provide rule configurations and business goals to the Support Tool 116. The rules may then be provided to the Planner 1814. The Planner 1814 may utilize the configured rules and pricing optimizations to generate a pricing plan for the products of the Stores 124. Plans may include pricing schedules, promotion schedules and discount schedules. The plan generated by the Planner 1814 may then be provided to the Distributor 1818 for dissemination and implementation by the Stores 124.

The Stores 124 may provide feedback POS data to a Receiver 1820. This data may be used to determine relative success of the markdown plan. The Receiver 1820 may provide this data to the Econometric Engine 104 and the Rule Updater 1824. The Econometric Engine 104 may provide new demand coefficients, where necessary. These demand coefficients may be used to provide a new set of price optimizations. The Rule Updater 1824 may update the configured rules. The rule updates along with the new price optimizations may then be provided to the Plan Re-optimizer 1822 where the plan is re-optimized. The re-optimized plan may be provided to the Stores 124 via the Distributor 1818. Also, the Reporter 1816 may provide a reoptimization report to the User 1802.

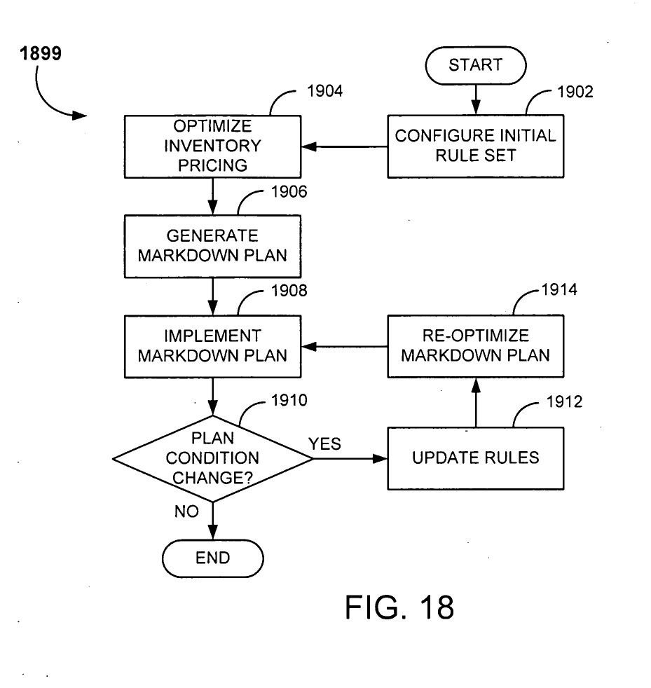

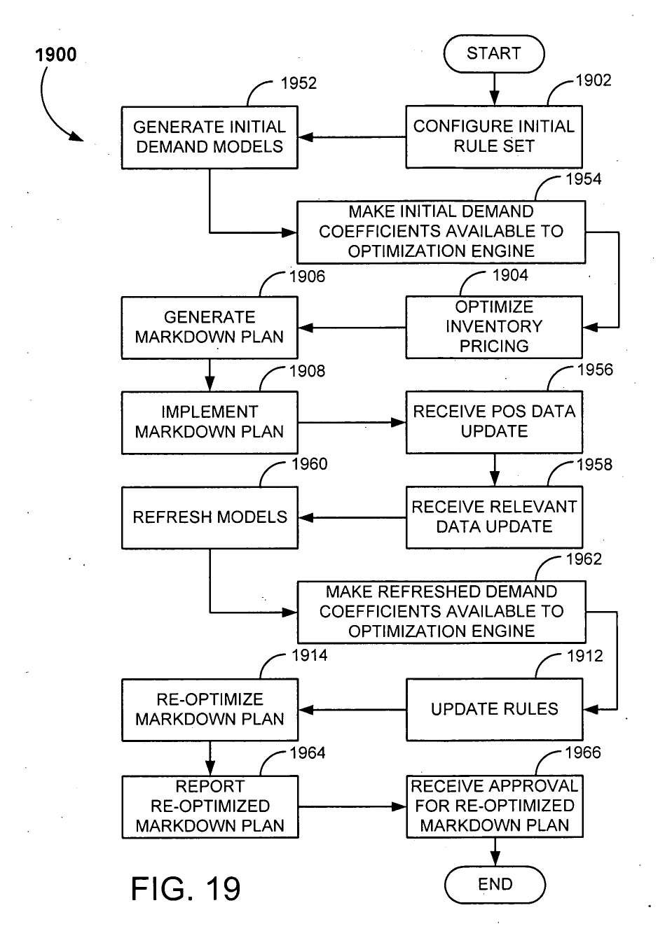

FIGS. 18 and 19 show flow charts illustrating high level process for generating and re-optimizing markdown plans in accordance with two alternate embodiments of the present invention. These illustrated processes are intended to be exemplary in nature, and as such do not limit one another in scope or process.

The embodiment illustrated at FIG. 18, and shown generally at 1899, includes reoptimization due to triggering events and includes markdown plan tuning. Here, the process begins and then progresses to step 1902 where initial rule sets are configured. Configuration of the initial rules may be preconfigured according to default standards.

Additionally, in some embodiments, the user may be able to select at least one plan “disposition”, wherein each disposition includes a set of preconfigured defaults which enable the particular goals of the disposition. For example, an ‘aggressive’ disposition may have a default configuration which includes high thresholds, large markdown allowances and an emphasis in expansion of market share as a primary goal over profitability. Conversely, a ‘conservative’ disposition may be available. Such a configuration preset may include limited markdown allowances, and an emphasis on profitability.

Lastly, in some embodiments, the user may be able to manually configure the initial rules. In such embodiments, the user may configure each initial rule category individually. Alternatively, the user may select only particular rules in which to configure. In these situations, the rules not configured by the user may utilize the default preconfigured settings as explained above. In this way, the user may generate a personalized configuration scheme. In some embodiments, the user may be able to save this configured rule scheme for use on later planning sessions.

The process then proceeds to step 1904 where inventory pricing is optimized. Plan optimization may occur at the Optimization System 100 in the manner detailed in above. Optimization may be restrained by the initial rules that were configured at step 1902. As noted above, the Econometric Engine 104 processes the transformed data to provide Demand Coefficients 128 for a set of equations that may be used to estimate demand (volume sold) given certain marketing conditions (i.e., a particular store in the chain), including a price point. The equations utilized may include linear algebraic equations, Bayesian statistical methodologies or any appropriate modeling technique. The Demand Coefficients 128 are provided to the Optimization Engine 112. Additional processed data from the Econometric Engine 104 may also be provided to the Optimization Engine 112. The Financial Model Engine 108 may receive transformed data from the Second Data Transformation Engine 102 and processed data from the Econometric Engine 104. The transformed data is generally cost related data, such as average store labor rates, average distribution center labor rates, cost of capital, the average time it takes a cashier to scan an item (or unit) of product, how long it takes to stock a received unit of product and fixed cost data. The Financial Model Engine 108 may process the data to provide a variable cost and fixed cost for each unit of product in a store. The processing by the Econometric Engine 104 and the processing by the Financial Model Engine 108 may be done in parallel. Cost Data 136 is provided from the Financial Model Engine 108 to the Optimization Engine 112. The Optimization Engine 112 utilizes the Demand Coefficients 128 to create a demand equation. The Optimization Engine 112 is able to forecast demand and cost for a set of prices to calculate net profit (margin).

In some embodiments, the Optimization Engine 112 may be configured to generate Demand Coefficients 128 for each item in the store separately. Moreover, the Optimization Engine 112 may be configured to generate Demand Coefficients 128 for select subsets of products. Such subsets may include items that are to be discontinued, products in high demand, products with subpar performance, products with cost changes, or any other desired criteria.

Moreover, Demand Coefficients 128 may be generated for each product separately, or may generate more accurate Demand Coefficients 128 that take into account cross elasticity between products. While optimizing including cross elasticity effects may be more accurate, the processing requirements are greatly increased for such calculations. In some embodiments, the user may select whether to account for such cross elasticity effects. In some alternate embodiments, the Optimization System 100 may provide the user suggestions as to whether to account for such cross elasticity effects, or may even automatically determine whether to account for such cross elasticity effects.

In order to facilitate such a system of automated modeling equation decisions, every product may include an aggregate cross elasticity indicator. Said indicator may rapidly provide information as to the relative degree of cross elasticity any particular product is engaged in. For example, a product such as hamburger buns may include a high cross elasticity indicator, since sales of hamburger buns may exert a large degree of elasticity upon a number of other products such as charcoal, hamburger meat, ketchup and other condiments. Alternatively, apples may have a low relative cross elasticity indicator. The Optimization System 100 may aggregate the cross elasticity indicators of the products to be optimized. A threshold may be configured, and if the aggregate indicators are above the threshold then the set of products that are being optimized for may be assumed to have a relatively strong degree of cross elasticity effects. In such a situation, the Optimization System 100 may then opt to utilize models which include cross elasticity. Alternatively, the Optimization System 100 may simply utilize cross elasticity models when the optimization includes under a particular product number. This ensures that a large optimization is not helplessly mired in massive calculations.

After optimization, the process then proceeds to step 1906 where the initial plan is generated. The plan typically includes the optimization from step 1904 as restrained by the rule set from step 1902. The initial markdown plan may include a set of prices, promotions and markdown schedules for the products.

At step 1908 the markdown plan generated at step 1906 is implemented. Plan implementation may include dissemination of pricing to individual stores for posting to consumers. This may be done by having the planner 117 send the plan 118 to the stores 124 so that the stores carry out the plan. In one embodiment, the support tool provides a graphic user interface that provides a button that allows the planner to implement the plan. The support tool would also have software to signal to the stores to implement the plan. In another embodiment, software on a computer used by the planner would integrate the user interface of the support tool with software that allows the implementation of the plan displayed by the support tool by signaling to the stores to implement the plan. In some alternate embodiments, the pricing of the products may be automatically implemented, as is more typical for bulk and limited order sales, and in virtual, catalog or web-based store settings.

The process then proceeds to step 1910 where an inquiry is made as to whether there is a plan condition change that may warrant a markdown plan re-optimization. Such condition changes may include cost changes, divergence of actual sales from forecasts, business rule change, world event changes, product changes, or other condition changes. If there is a condition change the process then proceeds to step 1912 where the rules are updated. Rule updates may include reconfiguration of any of the rules that were set at step 1902. After rule update, the process proceeds to 1914 where the markdown plan is re-optimized. Re-optimization may include application of the updated rules to preexisting demand forecasts, or may include new forecast generation. Additionally, if all the rules cannot be satisfied, the system may be configured to selectively relax the lowest priority rules in order to satisfy the higher priority rules. Thus, the system also allows for the user to specify the relative hierarchy or importance of the rules. Selection on whether to regenerate product demand models for forecasts may depend heavily upon what kind of condition change warranted the re-optimization. For example, if the condition change includes a market-wide event, such as a hurricane, demand models may become invalid and new modeling and forecasts may be necessary. However, if the condition change is a cost change, or change of business policy, old forecasts may be still relevant and usable. After re-optimization of the markdown plan, this markdown plan may be implemented at step 1908, in the manner discussed above.

Markdown plan reoptimization allows for a long term markdown plan to be corrected over the short term. This enables corrections if the long term plan has an error, which in the short term may be less significant, but over the long term may be more significant.

As noted, current events may change the accuracy of a long term model. Such current events may be a change in the economy or a natural disaster. Such events may make a six-month markdown plan using data from the previous year less accurate. The ability to re-optimize the markdown plan on at least a weekly basis with data from the previous week makes the plan more responsive to current events.

Tuning and re-optimization of the markdown plan may, additionally, identify poor-performing promotions. The use of constant updates helps to recognize if such a plan creates business problems and also allows a short term tuning to avoid further damage. For example, a promotion plan may predict that a discount coupon for a particular product for a particular week will increase sales of the product by 50%. A weekly update will within a week determine the accuracy of the prediction and will allow a tuning of the plan if the prediction is significantly off.

The system may provide that if a long term markdown plan is accurate within a certain percentage, the long term markdown plan is not changed. In such embodiments, the system may allow an automatic reoptimization when a long term plan is not accurate within a certain percentage. In another embodiment, the planner may be allowed to decide whether the long term markdown plan is in enough agreement with the updated data so that the long term markdown plan is kept without re-optimization.

Else, if at step 1910 re-optimization of the markdown plan is not desired, the process then ends.

The embodiment illustrated at FIG. 19, and shown generally at 1900, includes routinely scheduled reoptimization of the markdown plan. Here, the process begins and then progresses to step 1902 where initial rule sets are configured in a manner similar to that of FIG. 18. Configuration of the initial rules may be preconfigured according to default standards. Additionally, in some embodiments, the user may be able to select at least one plan “disposition”, as previously discussed. Likewise, the user may be able to manually configure the initial rules. In such embodiments, the user may configure each initial rule category individually. Alternatively, the user may select only particular rules in which to configure. In these situations, the rules not configured by the user may utilize the default preconfigured settings as explained above. In this way, the user may generate a personalized configuration scheme. In some embodiments, the user may be able to save this configured rule scheme for use on later planning sessions.

The process then proceeds to step 1952 where initial demand models are generated. As noted above, the Econometric Engine 104 processes the transformed data to provide Demand Coefficients 128 for a set of equations that may be used to estimate demand (volume sold) given certain marketing conditions (i.e. a particular store in the chain), including a price point. The equations utilized may include linear algebraic equations, Bayesian statistical methodologies or any appropriate modeling technique.

Demand Coefficients 128 may be generated for each product separately, or may generate more accurate Demand Coefficients 128 that take into account cross elasticity between products. While optimizing including cross elasticity effects may be more accurate, the processing requirements are greatly increased for such calculations. In some embodiments, the user may select whether to account for such cross elasticity effects. In some alternate embodiments, the Optimization System 100 may provide the user suggestions as to whether to account for such cross elasticity effects, or may even automatically determine whether to account for such cross elasticity effects.

The process then proceeds to step 1954 where the initial Demand Coefficients 128 are provided to the Optimization Engine 112. As previously discussed, the Financial Model Engine 108 may also provide a variable cost and fixed cost for each unit of product in a store. The processing by the Econometric Engine 104 and the processing by the Financial Model Engine 108 may be done in parallel. Cost Data 136 is provided from the Financial Model Engine 108 to the Optimization Engine 112.

The process then proceeds to step 1904 where inventory pricing is optimized. Plan optimization may occur at the Optimization System 100 in the manner detailed above. Optimization may be restrained by the initial rules that were configured at step 1902. The Optimization Engine 112 utilizes the Demand Coefficients 128 to create a demand equation. The Optimization Engine 112 is able to forecast demand and cost for a set of prices to calculate net profit (margin).

In order to facilitate such a system of automated modeling equation decisions, every product may include an aggregate cross elasticity indicator as detailed above The Optimization System 100 may aggregate the cross elasticity indicators of the products to be optimized. A threshold may be configured, and if the aggregate indicators are above the threshold then the set of products that are being optimized for may be assumed to have a relatively strong degree of cross elasticity effects. In such a situation, the Optimization System 100 may then opt to utilize models which include cross elasticity. Alternatively, the Optimization System 100 may simply utilize cross elasticity models when the optimization includes under a particular product number. This ensures that a large optimization is not helplessly mired in massive calculations.

After optimization, the process then proceeds to step 1906 where the initial markdown plan is generated. The plan typically includes the optimization from step 1904 as restrained by the rule set from step 1902. The initial markdown plan may include a set of prices, promotions and markdown schedules for the products.

At step 1908 the markdown plan generated at step 1906 is implemented. Plan implementation may include dissemination of pricing to individual stores for posting to consumers. This may be done by having the planner 117 send the plan 118 to the stores 124 so that the stores carry out the plan in the manner described previously.

The process then proceeds to step 1956 where new Point of Sales (POS) data is received. POS data may be received on a regular schedule, such as on a weekly basis. Additionally, other relevant data may additionally be received at step 1958. Such relevant data may include inventory data, changes in out dates, and other significant data.

The process then proceeds to step 1960 where models are refreshed. Markdown models need to be updated frequently since initial models often run on short life cycle products with little data history. POS data will arrive and the model should pull in this data to reflect updates to the coefficients in the models. Significant variances (greater or less than expected) should result in a modification in the coefficients and the resulting forecasts. Modeling refreshment may have different scope levels dependent upon size of model refresh and available processing resources. For example, a minimum scope for the model refresh is the products already implemented in markdown plan and active in stores. An intermediate scope could be to use triggers to update products on draft/approved markdown plans that have not yet been implemented. A broad scope, which is preferable but demands more processing resources, includes all products having coefficients updated, so that any markdown plans created (even those without a formal trigger) reflect the best understanding of consumer demand. In some embodiments, modeling refresh will be performed on one or more scopes dependent upon user configuration, size of modeling refresh, available processing resources and other recent modeling refresh activity.

The out date of a product may be defined as the plan date beyond which the product will not be available for sale at a particular location or groups-of-locations. If the out date of a product is supplied, it impacts the estimation of the lifecycle coefficient for that product. Forecasts for products beyond their scheduled out date, go to zero. Customer interviews have shown that out dates are not always precisely known, and modifications to targeted out dates do occur either because of a delay in the arrival of the replacement merchandise, or because of a merchant decision to extend a season due to weather, etc.

As a result, model refreshes may account for changes in out dates, so that if these out dates shift to a later date (the most common scenario) there is an adequate forecast on the impact on the product and sales are not arbitrarily reduced to zero.

Model refresh may additionally be enabled to allow the addition of new products to the model. This then enables products to be added to a planned markdown. This may be desired when a user accidentally missed these products initially, or when new sales information suggests that the products are now candidates for markdowns. In cases where these products have a strong relationship to products already on markdown, the preference may be to add these to an existing plan, rather than create a new plan.

Further, the system may also allow for linking newer products to existing products to allow for information sharing for an accurate read on the elasticity. For example, a retailer is selling different types of cell phone chargers and plans to put a charger labeled UPC_B on the markdown for the first time. In cases when sufficient history is not available, the user may decide to link it to an existing product (another cell phone charger, say UPC_A). This is interpreted as the user intent to borrow information (consumer preferences, elasticity estimates) from UPC_A, in cases when sufficient data is not available from UPC_B. This process may be referred to as “product linking”.

The process then proceeds to step 1962 where the refreshed Demand Coefficients 128 are provided to the Optimization Engine 112. Also, updated Cost Data 136 may be provided from the Financial Model Engine 108 to the Optimization Engine 112.

The process then proceeds to step 1912 where the rules are updated. Rule updates may include reconfiguration of any of the rules that were set at step 1902. Rule updates may include both user reconfigurations of rules as business strategy changes, and automatic rule updates to account for previous pricing markdown activity to reflect what has actually occurred to date. For example, if one markdown has already occurred and a maximum of 3 markdown occasions are permitted, then the new optimization will have to adjust the constraint to 2 markdowns. After rule updating, plan timing is adjusted based on known shifts in out dates (not shown).

After rule update and timing adjustments, the process proceeds to 1914 where the markdown plan is re-optimized. Re-optimization may include application of the updated rules to refreshed demand forecasts.

After re-optimization of the markdown plan, the re-optimized markdown plan may be reported at step 1964. Reporting may include an overall report that highlights all plans with changes. Also, cross category plan may be reported hat summarizes all specific schedule changes. The cross category plan may be configured to have the ability to review changes without having to drill down separately into each plan.

Reporting may additionally be enabled to include exception based reporting on schedule changes (e.g., only show schedules in which Markdown %'s changed by more than a pre-configured percentage or shifted dates by more than a configured Weeks. Likewise, reporting may also include an updated financial forecast for the plan that blends actual to-date data with new forecasted results for the plan.

Then, at step 1966, the plan may be approved by the user. The re-optimized plan may then be implemented (not shown). The process then ends.

It should be noted that markdown plan refresh and reoptimization may occur at regularly scheduled intervals, as well as in response to condition changes. As such, the embodiments illustrated at FIGS. 18 and 19 may be parallel and contemporaneous processes for pricing markdown reoptimization.

The model refresh process may be configured to be scheduled to occur at a set time, for example a particular day of each week. This refresh may generally occur simultaneously across categories, but the configuration of the schedule may enable the possibility of only certain categories being updated in a given time period. This may be of use because some retailers may stagger the number of markdowns they update each time period to account for variances in store labor.

Additionally, automated refresh may be configured to allow for a priority sequence to be set by category/department so that the highest value categories are sequenced first in the process. While the given example envisions this process occurring on a weekly basis, for super-seasonal or perishable products, it is possible that refresh and reoptimization occurs more frequently, such as on a daily basis. Therefore the configuration of the automation schedule may be readily configurable by user or automatically by product type and seasonality.

The model refresh process may additionally be scheduled to run an update based on when the POS, Product Status, and Inventory data arrives. For example, the process may be configured to automatically run based on when this data actually is received. This enables optimal turn around despite variances on when the data is collected.

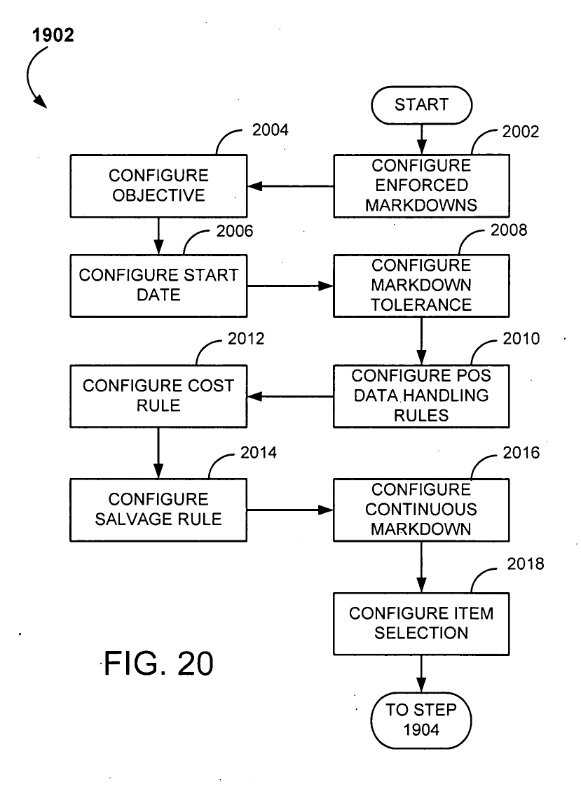

FIG. 20 shows a flow chart illustrating configuring the rules for markdown plan development, shown generally at 1902. The process begins from step 2002 where enforced markdowns are configured. Enforced markdowns include setting a markdown for a product during a particular time period. Markdown enforcements may be provided in terms of dollar amounts, or percentages.

The process then proceeds to step 2004 where the objective is configured. Objective may include the maximization of profits, or maximization of volume. When profit is maximized, it may be maximized for a sum of all measured products. Such a maximization may not maximize profit for each individual product, but may instead have an ultimate objective of maximizing total profit. Optionally, the user may select any subset from the universe of the products to measure profit maximization.

The process then proceeds to step 2006 where the start date is configured. Start date may include a price execution date, as well as markdown start dates. In some embodiments, users may want to be able to specify different markdown start dates for each store-group or product group. This means that in the same scenario, different store-SKUs may have to start their markdowns on different dates. This is slightly different from the price execution date. The price execution denotes the date by which they can get their prices into the store. A markdown prior to price execution is not relevant or practical since the retailers do not have time to take action on it.

Prior to the markdown start date, the system may use previously recommended prices. In some embodiments, previously recommended prices may simply be the initial prices; thus price may stay constant at the initial prices and there will be no markdowns. However, in re-optimization, the situation may arise where the previously recommended prices might contain a markdown. If the markdown start date has not changed between the first optimization and the re-optimization, previously recommended prices may stay constant. Else, if the markdown start-date is changed, a new optimization may be run, as opposed to a re-optimization.

The process then proceeds to step 2008 where the markdown tolerance may be configured. Markdown tolerance may be provided to the optimizer for generation of solution. In some embodiments, the optimizer may include a 3^{rd} party solver, such as General Algebraic Modeling System (GAMS). A narrower tolerance may provide a more accurate optimization; however, the modeling may take longer and consume greater processing resources. On the other hand, a wider tolerance may provide a faster, rougher optimization. In some embodiments, a default tolerance may be provided, such as 95%.

The process then proceeds to step 2010 where the handling of Point-of-Sale (POS) data is configured. POS handling rules may come into play when there is missing, or otherwise deficient, POS data. In some embodiments, POS handling may be configured to utilize forecasts for the missing or deficient data. In some alternate embodiments, zero or place-marker values may be provided for these missing data points. POS data deficiencies may be the result of communication errors, or data transmission latency.

The process then proceeds to step 2012 where cost rule may be configured. Likewise, at step 2014, salvage rules may be configured. In many cases users want to be able to manage leftover inventory while getting rid of the excess inventory as profitably as possible. For example, during the holiday season the shelf space for baking goods (sugar, baking mixes, butter, etc.) is expanded. After the holidays this space is reduced to everyday levels and there is a need to reduce the baking goods inventory to a lower everyday level. In some embodiments, users have the ability to specify what leftover inventory they should have at the stores to eliminate this holiday overstock.

Cost rules may limit markdown to the cost, or some percentage of the cost, of the product. This rule may become effective when a given product goes into closeout mode. Likewise, the salvage rule may provide the absolute minimum allowable price for markdown. This is the “last ditch” effort to recoup at least some portion of the cost when liquidating a product. The importance of a salvage rule includes that the retailer may have a better margin (or revenue) by selling the product at a salvage value than by marking it below the salvage value on the store shelves. Again, salvage rules may be dependent upon cost data, or some percentage thereof.

Alternatively, in some embodiments, a maximum lifetime markdown rule is also configured (not shown). The maximum lifetime markdown may be dependent upon some percentage of the initial price value. This value may represent the maximum discount level a particular manufacturer or retailer desires to have for a product. For some products considered “high end” it may be important that the purchasing public perceive the item as exclusive. Part of this image may include limits on discounts from the full price. In such instances, maximum lifetime markdowns may be of particular use.

Moreover, cost rules, salvage rules and maximum lifetime markdowns may be combined. In such instances the lower bound for the price may then be set to the mean of these rules, the median of the rules, or the highest or lowest threshold of these rules. The default may set the lower bound of the price to the highest of the cost salvage and maximum lifetime markdown rules, however, this rule combination may be configurable.

The process then proceeds to step 2016 where continuous markdown may be configured. Continuous markdown may include a markdown limit which may be configured. The optimizer may then set the markdown to any amount within the markdown limit, as is desired to fulfill a particular goal. Configuring the markdown limits may include setting limits as to the allowed degree of a markdown. These limits may include an upper as well as lower limit. Markdown limits may be provided in terms of dollar amounts, percentages, or may be tied to external data such as cost data and competitor pricing.

In some embodiments, a steepest markdown may be configured (not shown). Steepest markdown may limit the rate of markdown for a particular product. For example, the steepest markdown may be configured to be a maximum of a 5% drop over any week period. Thus, in this example, even if a 10% markdown is optimal, the first week may be a 5% markdown and then at the second week the markdown may be increased to 10%.

Likewise, in some embodiments, markdown timing may be configured (not shown). Configuring markdown timing may restrict the number of times markdowns may occur in a given time period. This may prevent markdowns from occurring too close together.

The process then proceeds to step 2018 where item selection is configured. Item selection may include user choice of products for optimization and/or re-optimization. Item selection may be user configured for each individual product, by grouping of related products, or by store levels. In some embodiments, item selection may be automated, such that items are selected by certain trigger events. Such events may include cost changes in the product, seasonality effects, competitor action, or any additional criteria.

In some embodiments, sell-through may additionally be configured (not shown). Configuring sell-through may include setting a percentage of starting inventory that is required to be sold by a certain date. For example, the user may configure a particular product to sell at least 80% of the starting inventory within a two week period. Such a rule may apply pressures to the volume maximization functions within the optimizer. Sell-through may be configured as a percentage of the original inventory, or as a number of products (i.e., sell 50,000 widgets in the first quarter).

The process then concludes by progressing to step 1904 of FIG. 19.

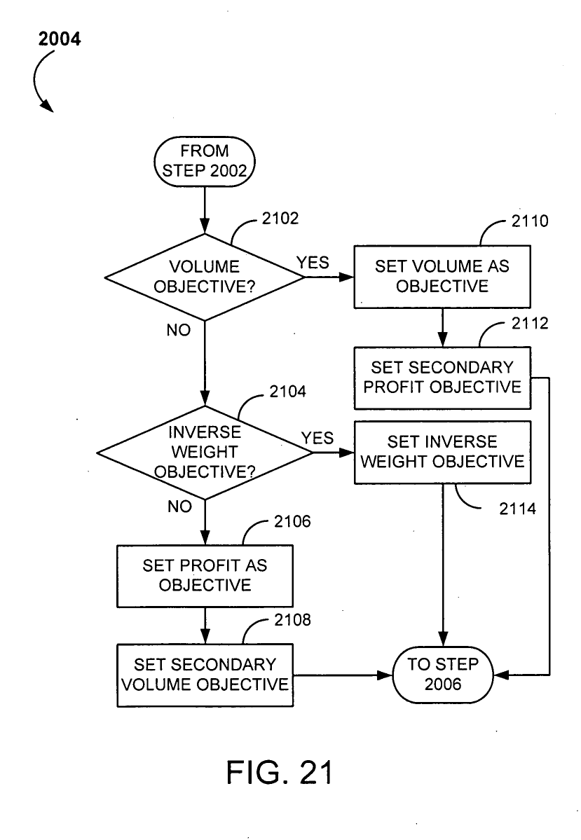

FIG. 21 shows a flow chart illustrating objective configuration, shown generally at 2004. The process begins from step 2002 of FIG. 20. The process then proceeds to step 2102 where an inquiry is made as to whether a volume objective is desired. A volume objective will set sales volume as the primary objective, at step 2110. Profit will then be set as a secondary objective at step 2112. The process then concludes by progressing to step 2006 of FIG. 20. Volume as the primary objective may be desired when a company is aggressively attempting to dominate a market, or otherwise increase market share. This tactic may be of particular use when introducing a new product line. A volume objective may rely heavily upon minimal markdown limits, as configured in FIG. 20.

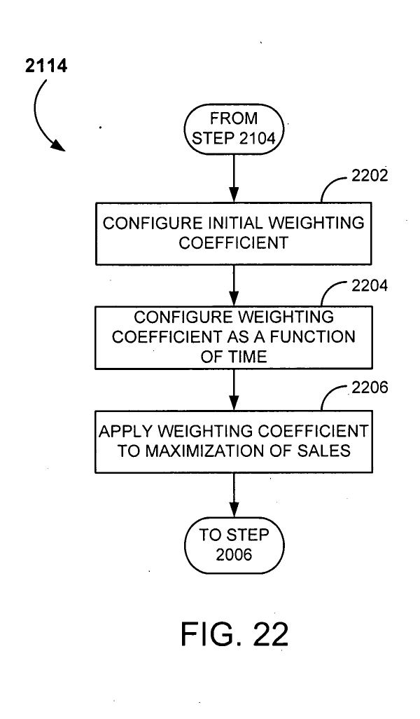

Else, if at step 2102 volume is not the desired primary objective, the process then proceeds to step 2104 where an inquiry is made as to whether an inverse weight objective is desired. Inverse weighting provides a primary profit maximization goal; however, as time progresses the secondary objective, maximizing volume, may be given increasing weight. This enables greater sell through over time. Inverse weighting will be discussed below in more detail at FIG. 22.

If inverse weight objective is desired, the process then proceeds to step 2114 where the inverse weighting objective is applied. The process then concludes by progressing to step 2006 of FIG. 20.

Otherwise, if at 2104 an inverse weighting function is not desired, the process then proceeds to step 2106 where profit is set as the primary objective. Volume is set as the secondary objective at step 2108. The process then concludes by progressing to step 2006 of FIG. 20.

FIG. 22 shows a flow chart illustrating setting inverse weighting objectives, shown generally at 2114. As noted above, inverse weighting provides a primary profit maximization goal; however, as time progresses the secondary objective, maximizing volume, may be given increasing weight. This enables greater sell through over time. An example of an inverse weighting function may be seen below:

$$VOLthenPFT = max {\sum }_{t} W ( t ) * SalesVol ( t )$$

In this example, VolthenPFT is the inverse weighting function. The SalesVol (or SalesVol(t)) term refers to the sales objective. The added argument t indicates the allowance for simple of complicated dependence on time dimension. Note that implicitly the summation would typically cover other dimensions such as over the product-set, store-set etc. This sales objective is multiplied by the weighting coefficient, W (or W(t) The argument t denotes dependence on time). This weighting coefficient, W(t), may be a linear function dependent upon time. In some embodiments, weighting coefficient, W, may be a more complicated weighting function that incorporates time, sell-through rates, events, POS data adhesion to forecasts, or any other desired factor. The sales objective multiplied by the weighting coefficient may then be summed, and the maximum may be taken to give the inverse weighting function.

For FIG. 22 the generation of a basic time-dependent weighting coefficient, W, is provided. The process begins from step 2104 of FIG. 21. The process then proceeds to step 2202 where the initial weighing coefficient is configured. This initial weighing coefficient provides the strength of the volume maximizing objective at the outset of the application of the inverse weighting objective. For example, an initial weighing coefficient of zero would make the objective purely profit maximizing at the outset. Conversely, a large initial weighing coefficient would make the objective more strongly volume maximizing at the outset.

The process then proceeds to step 2204 where the weighting coefficient, W, is configured as a function of time. As previously mentioned, weighting coefficient, W, may additionally be configured to incorporate sell-through rates, events, POS data adhesion to forecasts, or any other desired factor. Thus, the weighting coefficient, W, may be a function comprised of the initial weighing coefficient plus any time, or other factor, dependencies.

The process then proceeds to step 2206 where the weighting coefficient, W, is applied to maximization of sales. That is, to multiply the weighting coefficient, W, by the sales volume and take the maximum of the resulting sum.

The process then concludes by progressing to step 2006 of FIG. 20.

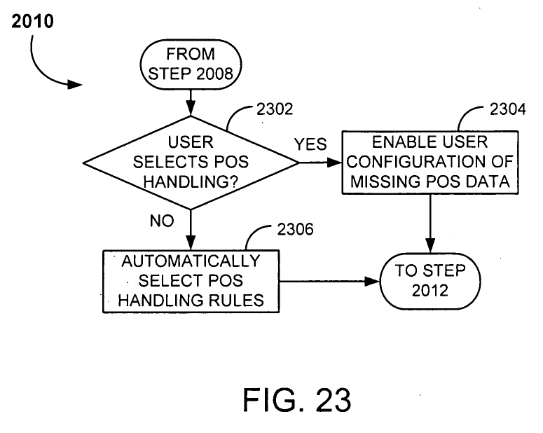

FIG. 23 shows a flow chart illustrating configuring rules for handling point of sales data, shown generally at 2010. The process begins from step 2008 of FIG. 20. The process then proceeds to step 2302 where an inquiry is made as to whether the user selects POS handling rules. If the user selects POS handling rules the process then proceeds to step 2304 where the user is enabled to configure any POS data. In some embodiments, the user may be able to manually enter missing POS data, or may select from forecast data, zero, or a place-marker. The process then concludes by progressing to step 2012 of FIG. 20.

Else, if at step 2302 the user does not desire to select POS handling, then the process proceeds to step 2306 where POS handling rules are automatically selected. The process then concludes by progressing to step 2012 of FIG. 20. For automatic POS handling selection, a default may be utilized, such as to always utilize forecast data. In some embodiments, however, it may be desirable to have a system which sometimes utilizes forecasts, and at other times replaces missing data with a zero value. For example, if data is provided from a retailer for the majority of products, yet data regarding other products is missing, it may be desirable to enter zero values for those products. This may be desirable since this gap in seemingly complete data may, in fact, reflect a lack of sales for the product during the reporting duration.

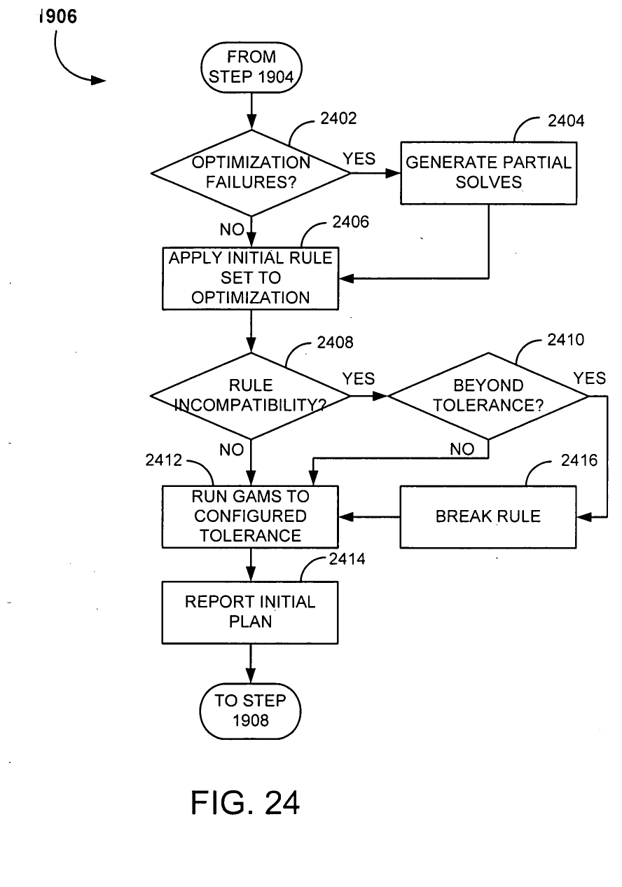

FIG. 24 shows a flow chart illustrating markdown plan generation, shown generally at 1906. The process begins from step 1904 of FIG. 19. The process then proceeds to step 2402 where an inquiry is made as to whether there is an optimization failure. If there is an optimization failure, a partial solve may be implemented at step 2404. Partial solves are made possible by segmenting product calculations. The process then proceeds to step 2406 where initial rule set, as configured at FIG. 20, is applied to the optimization.

Else, if at step 2402 there is no optimization failure, the initial rule set, as configured at FIG. 20, may be applied to the complete optimization, at step 2406. Then, at step 2408, an inquiry is made as to whether there is a rule incompatibility. If there are no incompatibilities, a GAMS run may be performed to the configured tolerance at step 2412.

Else, if a rule incompatibility exists the process then proceeds to step 2410 where an inquiry is made as to whether the rule incompatibility is beyond a tolerance level. If the incompatibility is below the tolerance, then GAMS may be run on the configured tolerance, at step 2412. This enables minor rule incompatibilities to be overlooked.

Otherwise, if at step 2410 the incompatibility is beyond tolerance then the process then proceeds to step 2416 where the rule is broken. In some embodiments, this may occur through rule relaxation, wherein rules are prioritized and the least priority rule which resolves the conflict is incrementally relaxed. The process then proceeds to step 2412 where a GAMS run may be performed to the configured tolerance. The GAMS run may result in a markdown plan which may be reported at step 2414. The process then concludes by progressing to step 1908 of FIG. 19.

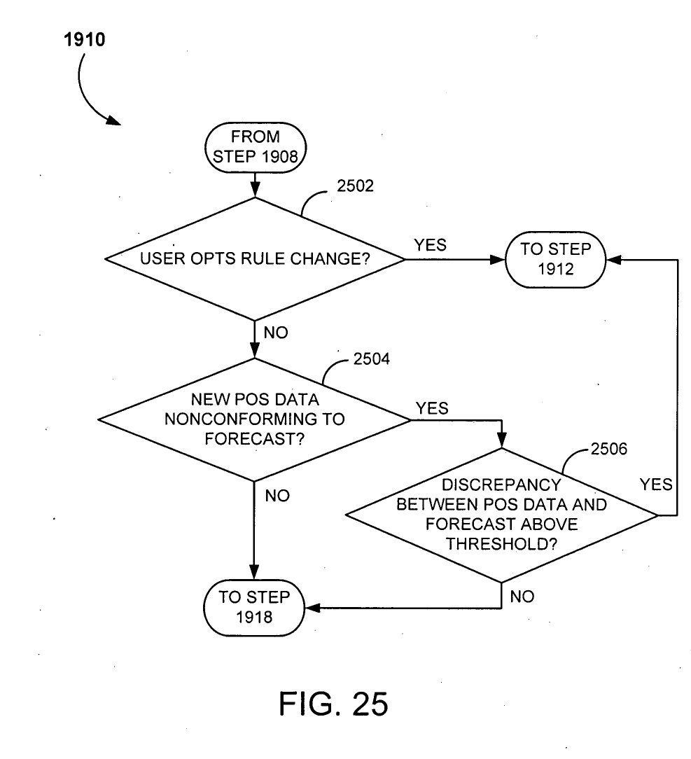

FIG. 25 shows a flow chart illustrating determination of plan change, shown generally at 1910. The process begins from step 1908 of FIG. 19. The process then proceeds to step 2502 where an inquiry is made as to whether the user opts to change rule configurations. If the user changes the rule configurations, the process concludes by progressing to step 1912 of FIG. 19.

Else, if the user is not choosing to change rule configuration,—the process then proceeds to step 2504 where an inquiry is made as to whether new POS data is provided which is does not conform to the forecast. This may occur when there is an unexpected event, or when the demand models used to develop the forecasts are deficient. If the new POS data conforms to forecast data, the process then concludes by progressing to step 1918 of FIG. 19.

Otherwise, if the new POS data is nonconforming to forecasts, then the process proceeds to step 2506 where an inquiry is made as to whether the discrepancy between POS data and forecasts are above a threshold. By checking against a threshold, minor deviations between POS data and forecasts may be ignored. However, discrepancies deemed significant may prompt a model refresh and a pricing markdown plan re-optimization. Thus, if the discrepancy is below the threshold, the process may conclude by progressing to step 1918 of FIG. 19. Else, if the discrepancy between POS data and forecasts is above the threshold, the process may conclude by progressing to step 1912 of FIG. 19.

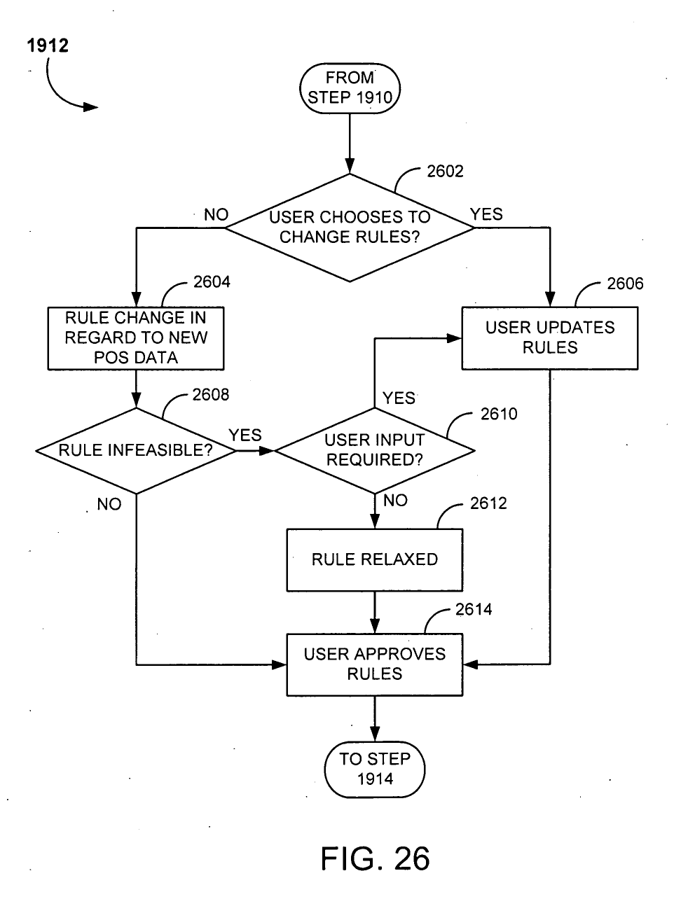

FIG. 26 shows a flow chart illustrating rule updating, shown generally at 1912. The process begins from step 1910 of FIG. 19. The process then proceeds to step 2602 where an inquiry is made as to whether the user chooses to change rules. If the user chooses to change the rules then the process proceeds to step 2606 where the user updates the rules. The process then proceeds to step 2614 where final rule set is approved by the user. The process then concludes by progressing to step 1914 of FIG. 19.

Else, if at step 2602 the user did not choose to reconfigure the rules, the process then proceeds to step 2604 where any rules that require changes due to new POS data is reconfigured. The process then proceeds to step 2608 where an inquiry is made as to whether the rule change is infeasible. If the new rule set is feasible, the process then proceeds to step 2614 where final rule set is approved by the user. The process then concludes by progressing to step 1914 of FIG. 19.

Otherwise, if the new rule set is found infeasible at step 2608, the process then proceeds to step 2610 where an inquiry is made as to whether user input is required. If user input is required the process then proceeds to step 2606, where the user updates the rules. The process then proceeds to step 2614 where final rule set is approved by the user. The process then concludes by progressing to step 1914 of FIG. 19.

Else, if user input is not required the process then proceeds to step 2612, where rules are relaxed. The process then proceeds to step 2614 where final rule set is approved by the user. The process then concludes by progressing to step 1914 of FIG. 19.

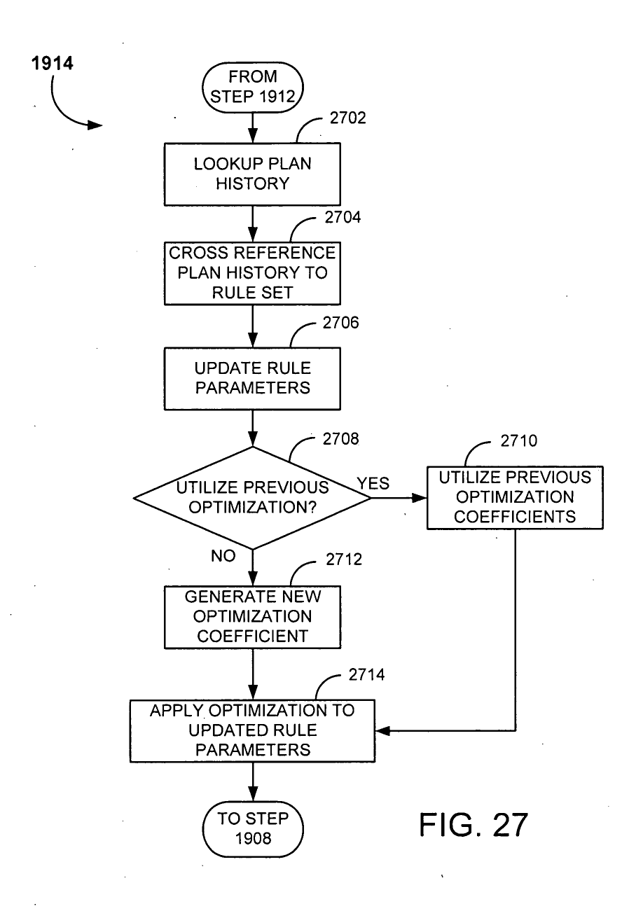

FIG. 27 shows a flow chart illustrating markdown plan re-optimization, shown generally at 1914. The process begins from step 1912 of FIG. 19. The process then proceeds to step 2702 where the markdown plan history is looked up. Then, at step 2704, the markdown plan history is cross referenced to the rule set. The process then proceeds to step 2706 where the rule parameters are updated. The system may be configured to distinguish between a starting price point, and the initial price. For an optimization, initial price (initprice) may be defined as the price before any markdowns. Because of the introduction of re-optimization, it is necessary to include another concept, a starting price point, or the price at the Price Execution Date (pePrice). The pePrice may be a marked down price; or it can be the initPrice. Additionally, pePrice might also be an infeasible price.

With re-optimization, the user is free to edit most of the rules involved. This may lead to infeasibilities in the previously recommended prices. For anything prior to the price execution date, the system may be configured to ignore that the user did not adhere to the rules, as rules are meant to be forward looking. However, some of these infeasibilities will affect the prices going forward.

For example, in general, infeasibilities can be divided into the following: 1) where the previously recorded price in the week before price execution is in itself an infeasible price. This can be because the allowable percent offs have changed, or because the price points have changed, or the maximum lifetime markdown % has changed. Overridden prices might also have been infeasible; 2) where the previously recommended prices prior to the price execution date do not adhere to the rules in the new optimization. This is of little concern, as optimization is forward looking; and 3) where the previously recommended prices prior to the price execution date, in addition to the new rules, make optimization after the price execution date infeasible. This can happen if more markdowns where taken in the past than the new total allows. This may also occur if the user changed the maximum lifetime markdown to something that is lower than a markdown taken in the past.

In some embodiments, such infeasibilities may be resolved, respectively, in the following ways: 1) the optimization may be changed to allow for infeasible pePrices. However, the system may be configured to move everything to a set of prices that are on the same schedule and on the same markdown level as soon as the lead time is passed; 2) the system may ignore non-adherence of previously recommended prices prior to the price execution date; and 3) the system may be configured to check to see if a product exceeded the maximum lifetime markdown allowed or has taken more than the total number of markdowns. If either of these conditions is true, then the system may be configured to not optimize for the entire schedule.

Additionally, implemented markdowns could very well be different across the schedule. Thus the system may be configured to allow for infeasible pePrices, and markdown them down to the same schedule as soon as possible.

Also, if the user has changed the maximum number of markdowns, it is possible to have surpassed this number of allowed markdowns. If a product has been marked down more than the maximum number allowed, the system may stop marking down the entire schedule.

Moreover, if the user changes the allowable percent off, it is possible that the previously recommended price is no longer feasible. Since prices can only go down, there might not be a feasible price point to go down to. In such a situation the system may remove all products from the optimization that do not have a feasible price point to go down to. All the other products may still be optimized. This check may be done together with the maximum lifetime markdown check. Alternatively, the system may be configured to not allow users to edit the percent offs field.

The process then proceeds to step 2708 where an inquiry is made as to whether utilize the previous optimization. When re-optimization is prompted by user rule changes, the previous optimization may be an acceptable demand model. Thus, by using the previous optimization time, and computational resources, may be conserved.

If the previous optimization may be utilized, the process then proceeds to step 2710 where the previous optimization coefficients are utilized. The optimization may then be applied to the updated rule parameters at step 2714. The process then concludes by progressing to step 1908 of FIG. 19.

Else, if at step 2708 the previous optimization is not to be utilized, such as in the situation where there are event changes that make the previous demand models inaccurate, then the process then proceeds to step 2712 where new optimization coefficients are generated. The optimization may then be applied to the updated rule parameters at step 2714. The process then concludes by progressing to step 1908 of FIG. 19.

In the specification, examples of product are not intended to limit products covered by the claims. Products may for example include food, hardware, software, real estate, financial devices, intellectual property, raw material, and services. The products may be sold wholesale or retail, in a brick and mortar store or over the Internet, or through other sales methods.

Additionally, it should be noted that the present invention may be embodied as entirely hardware, entirely software, or some combination thereof.

While this invention has been described in terms of several preferred embodiments, there are alterations, permutations, and substitute equivalents, which fall within the scope of this invention. It should also be noted that there are many alternative ways of implementing the methods and apparatuses of the present invention. It is therefore intended that the following appended claims be interpreted as including all such alterations, permutations, and substitute equivalents as fall within the true spirit and scope of the present invention.

What is claimed is:

1. A method for price markdown plan tuning, useful in association with a price optimization system, the method for markdown plan tuning comprising:
configuring an initial rule set;
generating an initial demand model wherein the initial demand model includes initial demand coefficients;
receiving a first optimization for inventory pricing from the price optimization system, wherein the optimization for inventory pricing utilizes the initial demand coefficients of the initial demand model and cost data;
generating a first markdown plan by applying the configured initial rule set to the received first optimization for inventory pricing;
implementing the first markdown plan;
receiving updated data, wherein the updated data mandates a re-optimization of the first markdown plan;
refreshing the initial demand model utilizing the updated data, wherein the refreshed demand model includes refreshed demand coefficients;
updating the initial rule set;
receiving a second optimization for inventory pricing from the price optimization system, wherein the optimization for inventory pricing utilizes the refreshed demand coefficients of the refreshed demand model and cost data;
re-optimizing the first markdown plan by applying the updated rule set to the received second optimization for inventory pricing;
reporting the re-optimized markdown plan;
receiving approval for the re-optimized markdown plan from a user; and
implementing the re-optimized markdown plan.

2. The method for price markdown plan tuning, as recited in claim 1, wherein configuring initial rule set includes configuring at least one of enforced markdowns, objective, start date, markdown tolerance, point-of-sales handling rules, cost rules, salvage rules, maximum lifetime markdown rule, continuous markdown and item selection.

3. The method for price markdown plan tuning, as recited in claim 2, wherein configuring the objective includes selecting at least one of a volume objective, a profit objective and an inverse weighing objective.

4. The method for price markdown plan tuning, as recited in claim 3, wherein the inverse weighing objective includes applying a weighing coefficient by the maximization of sales, and wherein the weighing coefficient is a function of time.

5. The method for price markdown plan tuning, as recited in claim 1, wherein the updated data includes at least one of point-of-sales data, user implemented rule changes, out date changes, cost data changes, inventory changes, and product linking.

6. The method for price markdown plan tuning, as recited in claim 1, wherein the reporting the re-optimized markdown plan includes generating at least one of an overall report which highlights all markdown plan changes, a cross category report which summarizes specific schedule changes to the markdown plan, an exception based report and a financial forecast for the re-optimized markdown plan.

7. The method for price markdown plan tuning, as recited in claim 1, wherein at least one of the first optimization and the re-optimization includes at least one failure, and wherein the at least one failure results in a partial solve.

8. The method for price markdown plan tuning, as recited in claim 1, wherein the updating the initial rule set further comprises:
looking up first markdown plan history;
cross referencing first markdown plan history with the initial rule set; and
updating rule parameters.

9. The method for price markdown plan tuning, as recited in claim 8, wherein the cross referencing first markdown plan history with the initial rule set includes identifying rule events that have occurred in the first markdown plan history.

10. The method for price markdown plan tuning, as recited in claim 9, wherein the updating rule parameters includes subtracting rule events that have occurred in the first markdown plan history from the initial rule set.

11. A price markdown plan tuning system, useful in association with a price optimization system, the system for price markdown plan tuning comprising:
a support tool configured to configure initial rule set;
an econometric engine configured to generate an initial demand model wherein the initial demand model includes initial demand coefficients;
a coupler configured to receive a first optimization for inventory pricing from the price optimization system, wherein the first optimization for inventory pricing utilizes the initial demand coefficients of the initial demand model and cost data from a financial engine;
a planer configured to generate a first markdown plan by applying the configured initial rule set to the received first optimization for inventory pricing;
a distributor configured to implement the first markdown plan;
a receiver configured to receive updated data, wherein the updated data mandates a re-optimization of the plan;
the econometric engine configured to refresh the initial demand model utilizing the updated data, wherein the refreshed demand model includes refreshed demand coefficients;
a rule updater configured to update the initial rule set;
the coupler configured to receive a second optimization for inventory pricing from the price optimization system, wherein the second optimization for inventory pricing utilizes the initial demand coefficients of the initial demand model and cost data from a financial engine;
a re-optimizer configured to re-optimize the first markdown plan by applying the updated rule set to the received second optimization for inventory pricing;
a reporter configured to report the re-optimized markdown plan;
the support tool configured to receive approval for the re-optimized markdown plan from a user; and
the distributor configured to implement the re-optimized plan.

12. The price markdown plan tuning system of claim 11, wherein the support tool is further configured to enable configuring of at least one of enforced markdowns, objective, start date, markdown tolerance, point-of-sales handling rules, cost rules, salvage rules, maximum lifetime markdown rule, continuous markdown and item selection.

13. The price markdown plan tuning system of claim 12, wherein the support tool is further configured to enable selecting at least one of a volume objective, a profit objective and an inverse weighing objective.

14. The price markdown plan tuning system of claim 13, wherein the inverse weighing objective includes applying a weighing coefficient by the maximization of sales, and wherein the weighing coefficient is a function of time.

15. The price markdown plan tuning system of claim 11, wherein the updated data includes at least one of point-of-sales data, user implemented rule changes, out date changes, cost data changes, inventory changes and product linking.

16. The price markdown plan tuning system of claim 11, wherein the reporter is further configured to generate at least one of an overall report which highlights all markdown plan changes, a cross category report which summarizes specific schedule changes to the markdown plan, an exception based report and a financial forecast for the re-optimized markdown plan.

17. The price markdown plan tuning system of claim 11, wherein at least one of the first optimization and the re-optimization includes at least one failure, and wherein the at least one failure results in a partial solve.

18. The price markdown plan tuning system of claim 11, wherein the rule updater further comprises:
a referencer configured to look up first markdown plan history;
a comparer configured to cross reference first markdown plan history with the initial rule set; and
a parameter updater configured to update rule parameters.

19. The price markdown plan tuning system of claim 18, wherein the comparer is configured to identify rule events that have occurred in the first markdown plan history.

20. The price markdown plan tuning system of claim 19, wherein the parameter updater is configured to subtract rule events that have occurred in the first markdown plan history from the initial rule set.
